(19) United States
(12) Patent Application Publication
(10) Pub. No.: US 2009/0164240 A1
(43) Pub. Date: Jun. 25, 2009

(54) METHODS FOR CONDUCTING A CLINICAL TRIAL

(75) Inventors: Nadav Friedmann, Layfayette, CA (US); Remi Barbier, Palo Alto, CA (US)

Correspondence Address: K&L Gates LLP, P.O. Box 1135, CHICAGO, IL, 60690, US

(73) Assignee: PAIN THERAPEUTICS, INC., San Mateo, CA (US)

(21) Appl. No.: 12/329,307

(22) Filed: Feb. 12, 2009

Related U.S. Application Data
(60) Provisional application No. 61/012,025, filed on Dec. 6, 2007.

(51) Int. Cl. G06Q 50/00

(52) U.S. Cl. 705/2

(57) ABSTRACT

The present disclosure relates generally to methods for selecting subjects for a clinical trial and includes methods for conducting a clinical trial to study the efficacy and/or safety of a drug by selecting subjects, for inclusion in a subsequent double-blind treatment period of the clinical trial, that do not exhibit adverse events to the drug. Methods for conducting a clinical trial may comprise the following: (1) an open-label titration period, (2) an adjustable dose treatment period and (3) a fixed dose treatment period. Optionally, the clinical trial may comprise a washout period prior to the open-label titration period. Also provided are methods for doing business by selecting subjects for a clinical trial for a drug that do not exhibit adverse events to the drug. Such methods may generate, revenue by reducing the length of time required to complete the clinical trial, increasing the likelihood that the drug will obtain regulatory approval and/or reducing the length of time it takes to bring advance the drug to market.

### CROSS-REFERENCE TO RELATED APPLICATIONS

This application claims priority to U.S. Provisional Application No. 61/012,025, filed on Dec. 6, 2007, which is hereby incorporated by reference in its entirety.

### FIELD

The present disclosure relates to novel methods for conducting a clinical trial by administering to subjects a range of amounts (e.g., from low to high) of a drug over an open label titration period to induce one or more adverse events in the subjects; and selecting subjects, for inclusion in a subsequent double-blind treatment period of the clinical trial, that do not exhibit one or more unacceptable adverse events in response to an amount within the range of amounts of drug administered during the open label titration period. The disclosure also relates to methods for doing business by selecting subjects for a clinical trial to improve the research, development, testing, commercialization, marketing, sales or use of the drug.

### BACKGROUND

A clinical trial is a carefully regimented research program that allows a clinical investigator to evaluate a new drug, medical device, or biologic (or a novel application of a known drug, medical device or biologic), in the treatment, prevention or diagnosis of a disease or condition. Specifically, a clinical trial allows for the determination of whether such a product is considered safe and/or effective, in light of the product's benefits relative to its risks.

Large economic costs are associated with the development, implementation and analysis of a clinical trial and the approval process of a new drug, biologic or medical device. For example, there are numerous regulatory bodies, both institutional and governmental, that oversee the conduct of a clinical trial and require various and complex safeguards to ensure participant safety. As such there exists a need to improve the design of a clinical trial to reduce its overall cost. Additionally, any change that may accelerate the commercialization and/or development of a potential drug can bring significant financial benefits.

### SUMMARY

The present disclosure relates generally to methods for selecting subjects for a clinical trial. Subjects may be selected for a clinical trial (e.g., phase II, III or IV) by administering to the subjects a range of amounts (e.g., from low to high) of a drug over an open label titration period to induce one or more adverse events in the subjects; and selecting subjects, for inclusion in a subsequent double-blind treatment period of the clinical trial, that do not exhibit one or more unacceptable adverse events in response to an amount (e.g., the highest amount) within the range of amounts of drug administered during the open label titration period. The selected subjects may be randomized into at least one first group to receive the drug and at least one second group to receive placebo. These methods may additionally comprise adjusting the dosage of drug administered to subjects in the first group for a period of time and then fixing the dosage of drug administered to the subject in the first group after the period of time has elapsed. Alternatively, the methods may additionally comprise fixing the dosage of drug administered to subjects in the first group without an adjustable dosage period. Alternatively, the methods may additionally comprise adjusting the dosage of drug administered to subjects in the first group without a fixed dosage period. For some drug testing, it may be advisable to discontinue medications (e.g., stop the administration of a variety of drugs), including those medications similar in effect to the study drug, in advance of selecting the subject for the clinical trial. Thus, prior to selecting the subject and/or administering the drug, the subjects may be subjected to a wash-out period.

The present disclosure also relates generally to methods for doing business by selecting subjects for a clinical trial for a drug to improve the use (e.g., regulatory approval, commercialization, marketing or sales) of the drug. Selecting subjects for a clinical trial that do not exhibit one or more adverse events for a drug allows a business to generate revenue, including increase revenue and/or reduce expense, by reducing the time it takes for a drug to obtain regulatory approval (e.g., reducing the time it takes to complete a clinical trial).

Methods are provided for selecting subjects for a double blind placebo-controlled clinical trial for testing the efficacy or safety of a drug by administering to subjects a range of amounts (e.g., from low to high) of a drug over an open label titration period to induce one or more adverse events in the subjects; and selecting subjects, for inclusion in a subsequent double-blind treatment period of the clinical trial, that do not exhibit one or more unacceptable adverse events in response to an amount (e.g., the highest amount) within the range of amounts of drug administered during the open label titration period.

Methods are provided for conducting a double-blind placebo controlled clinical trial by administering to subjects a range of amounts (e.g., from low to high) of a drug over an open label titration period to induce one or more adverse events in the subjects; selecting subjects for inclusion in the clinical trial that do not exhibit one or more unacceptable adverse events in response to an amount (e.g., the highest amount) within the range of amounts of drug administered during the open label titration period; and randomizing the selected subjects into at least two groups for the clinical trial, wherein the first group in the clinical trial receives drug and the second group in the clinical trial receives placebo.

Methods are provided for conducting a double-blind placebo controlled clinical trial by administering to subjects an amount of a drug which may induce one or more adverse events in the subjects over an open label titration period; selecting subjects that do not exhibit one or more unacceptable adverse events to the drug for the clinical trial; and randomizing the selected subjects selected into at least one first group to receive the drug and at least one second group to receive placebo. After randomization, the dosage of drug administered to subjects in the first group may be adjustable for a period of time, fixed for a period of time, or may be adjustable for a period of time and fixed for a subsequent period of time.

Methods are provided for conducting a double-blind placebo controlled clinical trial by administering to subjects an amount of a drug which may induce one or more adverse events in the subjects over an open label titration period prior to the clinical trial; selecting subjects for the clinical trial that do not exhibit during the open label titration period one or more unacceptable adverse events to the drug for inclusion in the clinical trial; and randomizing selected subjects into a first group to receive the drug and a second group to receive placebo. After randomization, the dosage of drug administered to subjects in the first group may be adjustable for a period of time, fixed for a period of time, or may be adjustable for a period of time and fixed for a subsequent period of time.

Methods are provided for conducting a double-blind placebo controlled clinical trial, the method comprising, a first phase comprising, administering to subjects an amount of a drug which may induce one or more adverse events in the subjects over an open label titration period, and selecting subjects that do not exhibit one or more unacceptable adverse events to the drug for the clinical trial; a second phase comprising, randomizing subjects selected in the first phase into at least one first group to receive the drug and at least one second group to receive a placebo; optionally or additionally, a third phase comprising, increasing or decreasing the dosage of medication administered to subjects in the first group; and optionally or additionally, a fourth phase comprising, fixing the dosage of drug administered to the subjects in the first group.

Methods are provided for doing business by selecting subjects for inclusion in a subsequent double-blind treatment period of a clinical trial that do not exhibit one or more unacceptable adverse events in response to an amount (e.g., the highest amount) within the range of amounts of drug administered during an open label titration period, conducting the clinical trial and seeking regulatory approval of the drug.

Methods are provided for doing business selecting subjects for inclusion in a subsequent double-blind treatment period of a clinical trial that do not exhibit one or more unacceptable adverse events in response to an amount (e.g., the highest amount) within the range of amounts of drug administered during an open label titration period; randomizing the selected subjects into at least two groups for the clinical trial, wherein the first group in the clinical trial receives drug and the second group in the clinical trial receives placebo, conducting the clinical trial and seeking regulatory approval of the drug.

Methods are also provided for doing business by selecting subjects for a clinical trial that do not exhibit during the open label titration period one or more unacceptable adverse events to the drug for inclusion in the clinical trial; randomizing selected subjects into at least one first group to receive the drug and at least one second group to receive placebo; and seeking regulatory approval of the drug. After randomization, the dosage of drug administered to subjects in the first group may be adjustable for a period of time, fixed for a period of time, or may be adjustable for a period of time and fixed for a subsequent period of time.

Methods are provided for doing business by selecting subjects for a clinical trial that do not exhibit during the open label titration period one or more unacceptable adverse events to the drug for inclusion in the clinical trial; randomizing selected subjects into a first group to receive the drug and a second group to receive placebo; and seeking regulatory approval of the drug. After randomization, the dosage of drug administered to subjects in the first group may be adjustable for a period of time, fixed for a period of time, or may be adjustable for a period of time and fixed for a subsequent period of time.

Methods are provided for doing business by conducting a clinical trial with a first phase comprising, selecting subjects for the clinical trial that do not exhibit during an open label titration period one or more unacceptable adverse events to the drug for inclusion in the clinical trial; a second phase comprising, randomizing subjects selected in the first phase into at least one first group to receive the drug and at least one second group to receive a placebo; optionally or additionally a third phase comprising, increasing or decreasing the dosage of medication administered to subjects in the first group; optionally a fourth phase comprising, fixing the dosage of drug administered to the subjects in the first group; and seeking regulatory approval of the drug.

Methods are provided for doing business by selecting subjects for a clinical trial that do not exhibit adverse events to a drug by administering to subjects a range of amounts (e.g., from low to high) of a drug over an open label titration period to induce one or more adverse events in the subjects; selecting subjects for inclusion in a clinical trial that do not exhibit one or more unacceptable adverse events in response to an amount (e.g., the highest amount) within the range of amounts of drug administered during the open label titration period and seeking regulatory approval of the drug.

Methods are provided for doing business by using subjects in a clinical trial that do not exhibit adverse events to a drug by administering to subjects a range of amounts (e.g. from low to high) of a drug over an open label titration period to induce one or more adverse events in the subjects; selecting subjects for inclusion in the clinical trial that do not exhibit one or more unacceptable adverse events in response to an amount (e.g., the highest amount) within the range of amounts of drug administered during the open label titration period; randomizing the selected subjects into at least two groups for the clinical trial, wherein the first group in the clinical trial receives drug and the second group in the clinical trial receives placebo; and seeking regulatory approval of the drug.

Methods are also provided for doing business by using subjects in a clinical trial that do not exhibit adverse events to a drug by administering to subjects an amount of a drug which may induce one or more adverse events in the subjects over an open label titration period; selecting subjects that do not exhibit one or more unacceptable adverse events to the drug for the clinical trial; randomizing selected subjects into at least one first group to receive the drug and at least one second group to receive placebo; and seeking regulatory approval of the drug. After randomization, the dosage of drug administered to subjects in the first group may be adjustable for a period of time, fixed for a period of time, or may be adjustable for a period of time and fixed for a subsequent period of time.

Methods are provided for doing business by using subjects in a clinical trial that do not exhibit adverse events to a drug by administering to subjects an amount of a drug which may induce one or more adverse events in the subjects over an open label titration period prior to the clinical trial; selecting subjects for the clinical trial that do not exhibit during the open label titration period one or more unacceptable adverse events to the drug for inclusion in the clinical trial; randomizing selected subjects into a first group to receive the drug and a second group to receive placebo; and seeking regulatory approval of the drug. After randomization, the dosage of drug administered to subjects in the first group may be adjustable for a period of time, fixed for a period of time, or may be adjustable for a period of time and fixed for a subsequent period of time.

Methods are provided for doing business by using subjects in a clinical trial that do not exhibit adverse events to a drug, comprising: a first phase comprising: administering to subjects an amount of a drug which may induce one or more adverse events in the subjects over an open label titration period, and selecting subjects that do not exhibit one or more unacceptable adverse events to the drug for the clinical trial; a second phase comprising, randomizing subjects selected in the first phase into at least one first group to receive the drug and at least one second group to receive a placebo; optionally a third phase comprising, increasing or decreasing the dosage of medication administered to subjects in the first group; optionally a fourth phase comprising, fixing the dosage of drug administered to the subjects in the first group; and seeking regulatory approval of the drug.

In some embodiments, regulatory approval is obtained. In some embodiments, the methods further comprise selling the drug. In some embodiments, the clinical trial is a phase II, III or IV clinical trial.

In some embodiments, the subject is a human.

In some embodiments, the drug is for the treatment of pain, arthritic conditions or inflammation.

In some embodiments, prior to selecting the subject and/or administering the drug, the subjects are subjected to a washout period whereby the subject discontinues medications, including those medications similar in effect to the study drug. For example, during a washout period for a clinical trial with an opioid, the subjects can stop taking all pain medication other than acetaminophen during the washout period.

In some embodiments, the drug is administered every four hours, every six hours, every eight hours, every twelve hours or every twenty-four hours. In some embodiments, the drug is taken with meals.

In some embodiments, the adjustment in the dosage is permitted during the initial (e.g., first four) weeks of the study period. In some embodiments, the adjustment in dosage is an increase in dosage. In some embodiments, the adjustment in dosage is a decrease in dosage. In some embodiments, the dosage is fixed during the study period. In some embodiments, the dosage is fixed only after a study period in which adjustment of the dose is permitted. In some embodiments in which there is a period of adjustment of the dosage. the dosage at the end of the adjustment period is selected as the dosage, for the fixed dosing period.

In some embodiments, subjects that receive the study drug may be tapered off of the drug at the end of the clinical trial.

In some embodiments, the methods further comprise selling the drug.

### DETAILED DESCRIPTION

The present disclosure provides methods for conducting a clinical trial (e.g., a phase II, III or IV clinical trial) to study the efficacy and safety of a drug by selecting subjects, for inclusion in a subsequent double-blind treatment period of the clinical trial, that do not exhibit adverse events to the drug. The double-blind treatment period of the clinical trial may comprise an adjustable dosing period, a fixed dosing period or an adjustable dosing period followed by a fixed dosing period. As used herein, a “clinical trial” refers to a study designed to evaluate the safety and/or efficacy of a drug, device or biologic in the treatment, prevention or diagnosis of a disease or condition in a subject. As used herein, “drug” specifically includes biologics. Methods for conducting a clinical trial may comprise the following: (1) an open-label titration period, (2) optionally or additionally, a double-blind placebo controlled adjustable dose treatment period and (3) optionally or additionally, a fixed dose treatment period. Optionally or additionally, the clinical trial may comprise a washout period prior to the open-label titration period.

The present disclosure also provides methods for doing business by selecting subjects for a clinical trial for a drug that do not exhibit adverse events to the drug. Such methods may generate revenue, including increase revenue and/or reduce expense, including, for example, by: reducing the length of time required to complete the clinical trial; increasing the likelihood that the drug will obtain regulatory approval; reducing the length of time it takes to bring advance the drug to market; identifying a large number of drop-outs in the clinical trial upfront (e.g., before they are randomized into the double-blind treatment period of the study); obtaining information about subjects' ability to comply with the randomized double-blind treatment period of the study, thereby reducing the size of the study (e.g., number of subjects needed to achieve a statistically significant response in the clinical endpoints; minimizing the number of subjects who drop out during the randomized double-blind treatment period of the study to increase the clinical accuracy and statistical rigor of the study; or reducing the size of the clinical study since subjects who enter the randomized double-blind treatment period have a better chance of finishing the study (e.g., number of subjects needed to achieve a statistically significant response in the clinical endpoints).

The methods described herein are suitable for the clinical evaluation of medications (e.g., drugs or biologics) including medications for nervous system disorders, such as pain or central nervous system disorders. These may include, for example, depression, anxiety, migraine, epilepsy, attention deficit or eating disorders. Such evaluations are hampered by the lack of homogeneity of the side effects inherent in the therapeutic index among the various groups enrolled in the clinical trial. The side effects magnify the challenges in application of valid, sensitive measurements of the effectiveness of therapies for the disorders. Exemplary drugs for the treatment of pain include opioids such as, for example, oxycodone, hydromorphone, oxymorphone, or hydrocodone. Exemplary drugs for the treatment of nervous system disorders include, for example, primary and secondary norepinephrine-reuptake inhibitors (e.g., amytriptyline, clomipramine, doxpin, impramine, trimipramine, amoxapine, desipramine, maprotiline, nortiptyline, protriptline), selective serotonin-reuptake inhibitors (e.g., citalopram, fluoxetine, fluvoxamine, paroxetine, sertraline, venlafaxine), atypical antidepressants (e.g., bupriopion, mirtazapine, nefazodone, trazodone), monamine oxidase inhibitors (e.g., phenelzine, tranylcypromine, selegiline), antiseizure drugs (e.g., carbamazepine, phenytoin, valproate, primidone, ethosuximide, or attention deficit drugs (e.g., RITALIN®, CONCERTA®).

An exemplary method for conducting a clinical trial includes, administering to subjects an amount of a drug which may induce one or more adverse events in a subject over an open label titration period; selecting subjects that do not exhibit adverse events to the drug for a double blind placebo controlled treatment period; randomizing the selected subjects into a first group to receive the drug and a second group to receive placebo in the double blind placebo controlled treatment period; permitting an adjustment of the dosage of study drug (e.g., study drug, placebo or reference drug) for a period of time; and fixing the amount of study drug administered to the subjects after the period of time has elapsed. Optionally, the clinical trial may comprise a washout period prior to the open-label titration period.

Subjects are provided an informed consent document by a member of the clinical trial team that includes details about the study, such as its purpose, duration, required procedures, and key contacts. The clinical trial team includes doctors and nurses as well as social workers and other health care professionals. The clinical team may check the health of the participant at the beginning of the trial, give specific instructions for participating in the trial, monitor the participant carefully during the trial, and stay in touch after the trial is completed. Further, the team may explain risks and potential benefits to the subject in the informed consent document. Subjects that agree to the informed consent document and meet certain criteria (e.g., inclusion/exclusion criteria) may be enrolled in an open label titration period. These criteria are based on such factors as age, gender, the type and stage of a disease, previous treatment history, and other medical conditions. Optionally, a washout period may be conducted prior to the enrollment of subjects in the open-label period. During the washout period, subjects may discontinue taking medication for an amount of time before the open label titration period begins, (e.g., four to ten days) since concomitant medication may obscure therapeutic endpoints.

The enrolled subjects may be administered an amount of a study drug, or titrated up to an amount of a study drug, to determine those subjects which exhibit adverse events to the study drug. Subjects that are able to tolerate the study drug (e.g., do not exhibit adverse events, including severe adverse events, to the study drug) may be selected for a double-blind placebo controlled study.

Adverse events may include: any treatment-emergent signs and symptoms (e.g., events that are marked by a change from the patient's baseline/entry status such as an increase in severity or frequency of pre-existing abnormality or disorder); all reactions from the study drug, an overdose, abuse of drug, withdrawal phenomena, sensitivity or toxicity to the study drug; apparently unrelated illnesses; injury or accidents; and/or extensions or exacerbations of symptoms, subjective patient-reported events, new clinically significant abnormalities in clinical laboratory, physiological testing or physical examination. Severe adverse events may include: death; a life-threatening event (e.g., the patient is at immediate risk of death from the reaction as it occurs); in-patient hospitalization or prolongation of existing hospitalization; a persistent or significant disability/incapacity (e.g., a substantial disruption of the patient's ability to carry out normal life functions); and/or a congenital anomaly/birth defect. Subjects that tolerate the study drug (e.g., do not exhibit one or more adverse effects) may be randomized into two or more groups (e.g. in a 1:1 ratio) to receive the study drug or placebo.

Adverse events exhibited by a subject may be indicated as unacceptable adverse events by the subject, a physician or both the subject and physician. Where the study drug is an opioid, unacceptable adverse events may include constipation, dizziness, somnolence, pruritis, nausea and/or vomiting.

Subjects that are randomized after the open label titration period may enter a double-blind placebo controlled adjustable treatment period for a period of time where they are initially administered the same dosage of study drug as administered during the open-label titration period, for example, the maximum titrated dose during the open label titration period. The placebo may be indistinguishable from the study drug. Subjects in the placebo group may be titrated down from the initial dosage of study drug during the first two weeks of the double-blind treatment period. For example, when the study drug is an opioid, subjects may be gradually tapered off the study drug (e.g, over a period of 0-15 days) depending on the dose of study drug administered to prevent the emergence of opioid withdrawal symptoms. During the double-blind treatment period, a subject, a physician or both the subject and physician may chose to increase the subject's dose of study medication (e.g., study drug, placebo or reference drug) if the subject still exhibits symptoms that the study drug is administered to treat and/or ameliorate (e.g., decrease, reduce or eliminate). Alternatively, a subject, a physician or both the subject and physician may chose to decrease the subject's dose of study medication during the double-blind adjustable treatment period if the subject is having unacceptable adverse events.

After an adjustable dose treatment period has elapsed, subjects may enter a fixed dose treatment period. The amount of drug administered to the subjects may be fixed at their last administered dose during the adjustable treatment period for the remainder of the clinical trial. Optionally, at the conclusion of the double-blind treatment period, patients administered the study drug may be gradually tapered off of study drug. For example, when the study drug is an opioid, subjects may be gradually tapered off the study drug (e.g, over a period of 0-15 days) depending on the dose of study drug administered to prevent the emergence of opioid withdrawal symptoms.

At points throughout the clinical trial, subjects are examined to determine the safety and efficacy of the drug. For example, clinical examinations may be performed throughout the trial and may include: vital signs (blood pressure, respiratory rate, heart rate and temperature), physical examinations, EKGs, clinical laboratory tests, adverse events and drug toxicity assessments. Subjects may choose to discontinue participation in the clinical trial at any time, for any reason, specified or unspecified, and without prejudice.

In some embodiments, the study may be an opioid. In some embodiments, the study drug may be an opioid. In some embodiments, the opioid is oxycodone, hydromorphone, oxymorphone or hydrocodone. In some embodiments, the opioid is alfentanil, allylprodine, alphaprodine, anileridine, apomorphine, apocodeine, benzylmorphine, bezitramide, butorphahol, clonitazene, codeine, cyclazocine, cyclorphen, cyprenorphine, desomorphine, dextromoramide, dezocine, diampromide, dihydrocodeine, dihydromorphine, dimenoxadol, dimepheptanol, dimethylthiambutene, dioxyaphetyl butyrate, dipipanone, eptazocine, ethoheptazine, ethylmethylthiambutene, ethylmorphine, etonitazene, fentanyl, heroin, hydrocodone, hydroxymethylmorphinan, hydromorphone, hydroxypethidine, isomethadone, ketobemidone, levallorphan, levorphanol, levophenacylmorphan, lofentanil, meperidine, meptazinol, metazocine, methadone, methylmorphine, metopon, morphine, myrophine, narceine, nicomorphine, norlevorphanol, normethadone, nalorphine, normorphine, norpipanone, ohmefentanyl, opium, oxycodone, oxymorphone, papavereturn, phenadoxone, phenomorphan, phenazocine, phenoperidine, pholcodine, piminodine, piritramide, propheptazine, promedol, profadol, properidine, propiram, propoxyphene, remifentanyl, sufentanyl, tramadol, tilidine, salts thereof, mixtures of any of the foregoing, mixed mu-agonists/antagonists, mu-antagonist combinations, or others known to those skilled in the art. Opioids include exogenous or endogenous opioids, including endorphin, beta-endorphin, enkephalin, met-enkephalin, dynorphin, orphanin FQ, neuropeptide FF, nociceptin, endomorphin, endormorphin-1, endormorphin-2.

In some embodiments, the study drug may treat and/or prevent pain. In some embodiments, the pain is chronic pain. In some embodiments, the chronic pain results from osteoarthritis, rheumatoid arthritis, psoriatic arthritis, gout, spondylarthropathris, ankylosing spondylitis, Reiter's syndrome, psoriatic arthropathy, enterapathric spondylitis, juvenile arthropathy, juvenile ankylosing spondylitis, reactive arthropathy, infectious or post-infectious arthritis, gonoccocal arthritis, tuberculous arthritis, viral arthritis, fungal arthritis, syphilitic arthritis, Lyme disease, calcium crystal deposition arthropathies, pseudo gout, non-articular rheumatism, bursitis, tenosynomitis, epicondylitis, carpal tunnel syndrome, a repetitive use injury, neuropathic joint disease, hemarthrosis, Henoch-Schonlein Purpura, hypertrophic osteoarthropathy, or multicentric reticulohistiocytosis. In some embodiments, the chronic pain results from an arthritis associated with a vasculitic syndrome, polyarteritis nodosa, hypersensitivity vasculitis, Luegenec's granulomatosis, polymyalgin rheumatica, joint cell arteritis, surcoilosis, hemochromatosis, sickle cell disease or another hemoglobinopathry, hyperlipo proteineimia, hypogammaglobulinemia, hyperparathyroidism, acromegaly, familial Mediterranean fever, Behat's Disease, lupus, systemic lupus erythematosis, hemophilia, or relapsing polychondritis.

In some embodiments, the chronic pain is associated with a joint, hip, knee, back (e.g. lower back) or neck, of the subject.

In some embodiments, the pain is measured as pain intensity. In some embodiments, the pain intensity is attenuated as compared to a pain intensity baseline of the subject. In some embodiments, the pain is measured on the pain subscale of the WOMAC Osteoarthritis Index. In some embodiments, the pain measurement of the subject is improved as compared to baseline pain measurement of the subject on the WOMAC pain subscale baseline of the subject. In some embodiments, the pain is measured by a patient or physician assessment. In some embodiments, the pain is measured on an 11-point numerical scale. In some embodiments, the pain is reduced by at least 1 point, as compared to the pain where a human subject is administered a placebo.

In some embodiments, the pain felt by the subject when walking on a flat surface, when going up or down stairs, at night while in bed, that disturbs the sleep of the subject, while sitting or lying down, or while standing is attenuated.

In some embodiments, the inclusion criteria for the clinical trial may include one or more or all of the following criteria: males and females who are ≧40 and ≦75 years of age; subjects that have moderate to severe pain in one or more hip or knee joint(s) for at least three months prior to a screening visit due to osteoarthritis as demonstrated by clinical and radiographic evidence according to the American College of Rheumatology (ACR) criteria for the diagnosis of osteoarthritis of the hip or knee; subjects that have moderate to severe pain in the hip or knee joint(s) while taking ≧4 days/week every week for the past four weeks prior to a screening visit one or more of the following types of oral analgesic medication(s): NSAIDs, COX-2 inhibitors, tramadol, opioids; subjects that have received no opioids within 72 hours of a screening visit and either: no opioids or an average daily opioid dose equivalent of oxycodone ≦20 mg or tramadol ≦200 mg within one week prior to a screening visit; or a daily opioid dose equivalent of oxycodone (>20 mg and ≦80 mg) or tramadol >200 mg within one week prior to a screening visit and had undergone an opioid taper prior to study entry; subjects that had a pain intensity score of ≧5 on an 11-point numerical scale at a screening visit; subjects that had a mean daily diary overall pain intensity of ≧5 on an 11-point numerical scale during the last two days of a washout period (Baseline PI; calculated by IVRS); subjects that had completed daily telephone diary pain intensity assessments for ≧75% days (calculated by IVRS) during the washout period and during the open-label titration period; subjects that had completed the open-label titration period and are able to tolerate study drug at 20 mg BID; subjects that had agreed to refrain from taking any pain medications other than study drug during the study period; subjects that are ambulatory; females who are postmenopausal, physically incapable of childbearing, or practicing an acceptable method of birth control; and subject must be able to understand and cooperate with study procedures, has access to a touch-tone telephone at home, and has signed a written informed consent form prior to any study procedures.

In some embodiments, the exclusion criteria for the clinical trial may include one or more or all of the following criteria: subjects that had a positive urine drug screen at a screening visit; subjects that had received a daily opioid dose equivalent of oxycodone >80 mg for 4 or more days/week during the week prior to a screening visit; subjects that had pain in the hip(s) or knee(s) caused by conditions other than osteoarthritis, e.g., malignancy, gout, inflammatory disease such as rheumatoid arthritis, fibromyalgia, recent trauma within the past six months, or infection; subjects that had a history of Paget's disease, or autoimmune diseases associated with arthritis (e.g. rheumatoid arthritis, lupus, Sjogren's are exclusionary diagnoses); subjects that had major surgery within three months prior to a screening visit or has surgery planned during the proposed study period; subjects that had received oral, intra-articular, or parenteral corticosteroid therapy within one month prior to a screening visit; subjects that had received an intra-articular injection of hyaluronic acid in the hip or knee within six months prior to a screening visit; subjects that weigh more than 300 lbs or less than 100 lbs; subjects that were pregnant or breast-feeding; subjects that had received an epidural or intrathecal infusion of any analgesic medication(s) within one month prior to a screening visit; subjects that had severe impairment of pulmonary function, hypercarbia, hypoxia, cor pulmonale, sleep apnea syndrome, severe/uncontrolled asthma, chronic obstructive pulmonary disease, or a history of respiratory depression; subjects that had a history of gastric bypass surgery; any gastric or small intestine surgery leading to malabsorption; or any disease that causes clinical malabsorption; subjects that had unstable cardiac disease (e.g. inadequately controlled hypertension, congestive heart failure, a history of myocardial infarction within the previous year); or patient has any health condition(s) that pose a significant health risk in the event of opioid withdrawal; subjects that had started, stopped, or changed the dose of the following medications within four weeks prior to a screening visit: monoamine oxidase inhibitors, tricyclic antidepressants, serotonin reuptake inhibitors or other antidepressants; gabapentin, pregabalin, and glucosamine/chondroitin; subjects that had started or stopped physical therapy, transcutaneous electrical nerve stimulation, chiropractic, osteopathic, acupuncture, or other complementary treatment within four weeks prior to a screening visit or is expected to undergo any changes in these therapies during the study; subjects that had received high doses of sedatives, hypnotics or tranquilizers that may, in the opinion of the investigator, increase the risk of opioid toxicity; subjects that had received phenothiazines or other agents that compromise vasomotor tone; subjects that had a history of alcohol or drug abuse within the past 5 years; subjects that had a medical illness/condition, psychiatric illness, and/or abnormal diagnostic finding that would interfere with the completion of the study, confound the results of the study, or pose risk to the patient; subjects that had a history of leukemia, lymphoma, myeloproliferative disease, multiple myeloma, or metastatic cancer; patient has a history of prostate, breast, thyroid or lung cancer within five years of study entry; or patient has a history of any other localized malignancy within two years of study entry. (Patients with treated localized prostate, breast, thyroid or lung cancer without recurrence for ≧five years, any other treated localized malignancy without recurrence for ≧2 years, or a history of curative treatment of basal or squamous cell carcinoma of the skin are not excluded); subjects that had a history of an allergic reaction or hypersensitivity to any of the study medications or structurally similar compounds: oxycodone, morphine, hydromorphone, hydrocodone, levorphanol, pentazocine, codeine, etc. or acetaminophen; subjects that had AST, ALT, or alkaline phosphatase >2 times the upper limit of normal; hematocrit <30%; creatinine ≧1.8; or ESR >20 from a screening visit; subjects that had previously received study drug; subjects that had participated in another investigational drug trial or therapeutic trial within 30 days of a screening visit; subjects that had taken analgesic medication (other than acetaminophen) during the washout period prior to enrollment; or patient has taken any analgesic medication (other than study drug) during the open-label titration period prior to randomization.

Methods are provided for selecting subjects for a clinical trial (e.g., phase II, III or IV) by administering to the subjects a range of amounts (e.g., from low to high) of a drug used for treatment and/or alleviation of pain over an open label titration period to induce one or more adverse events in the subjects; and selecting subjects for inclusion in the clinical trial that do not exhibit one or more unacceptable adverse events in response to an amount (e.g., the highest amount) within the range of amounts of drug administered during the open label titration period. Additionally, or optionally the selected subjects may be randomized into at least one first group to receive the drug and at least one second group to receive placebo. These methods may further comprise adjusting the dosage of drug administered to subjects in the first group for a period of time and fixing the dosage of drug administered to the subject in the first group after the period of time has elapsed. Alternatively, the methods may comprise fixing the dosage of drug administered to the subject in the first group without an adjustable dosage period. Optionally, prior to administering the drug the subjects may be subjected to a wash-out period.

Methods are also provided for doing business by selecting subjects for a clinical trial for a drug used for treatment and/or alleviation of pain that do not exhibit severe adverse events to the drug to improve the use (e.g., regulatory approval, commercialization, marketing or sales) of the drug. Selecting subjects for a clinical trial that do not exhibit severe adverse events for a drug allows a business to generate revenue, including increase revenue and/or reduce expense, by reducing the time it takes for a drug to obtain regulatory approval (e.g., reducing the time it takes to complete a clinical trial).

Methods are provided for selecting subjects for a double blind placebo-controlled clinical trial for testing the efficacy or safety of a drug used for treatment and/or alleviation of pain by administering to subjects a range of amounts (e.g., from low to high) of a drug over an open label titration period to induce one or more adverse events in a subject; and selecting subjects, for inclusion in a subsequent double-blind treatment period of the clinical trial, that do not exhibit one or more unacceptable adverse events in response to an amount (e.g., the highest amount) within the range of amounts of drug administered during the open label titration period

Methods are provided for conducting a double-blind placebo controlled clinical trial by administering to subjects a range of amounts (e.g., from low to high) of a drug used for treatment and/or alleviation of pain over an open label titration period to induce one or more adverse events in the subjects; selecting subjects for inclusion in the clinical trial that do not exhibit one or more unacceptable adverse events in response to an amount (e.g., the highest amount) within the range of amounts of drug administered during the open label titration period; and randomizing the selected subjects into at least two groups for the clinical trial, wherein the first group in the clinical trial receives drug and the second group in the clinical trial receives placebo.

Methods are provided for conducting a double-blind placebo controlled clinical trial by administering to subjects an amount of a drug used for treatment and/or alleviation of pain which may induce one or more adverse events in the subjects over an open label titration period; selecting subjects that do not exhibit one or more unacceptable adverse events to the drug for the clinical trial; randomizing the selected subjects selected into at least one first group to receive the drug and at least one second group to receive placebo; permitting an adjustment of the dosage of medication administered to subjects in the first group for a period of time; and fixing the dosage of drug administered to the subjects in the first group after the period of time has ended.

Methods are provided for conducting a double-blind placebo controlled clinical trial by administering to subjects an amount of a drug used for treatment and/or alleviation of pain which may induce one or more adverse events in the subjects over an open label titration period; selecting subjects that do not exhibit one or more unacceptable adverse events to the drug for the clinical trial; randomizing the selected subjects selected into at least one first group to receive the drug and at least one second group to receive placebo; and permitting an adjustment of the dosage of medication administered to subjects in the first group for the duration of the clinical trial.

Methods are provided for conducting a double-blind placebo controlled clinical trial by administering to subjects an amount of a drug used for treatment and/or alleviation of pain which may induce one or more adverse events in the subjects over an open label titration period prior to the clinical trial; selecting subjects for the clinical trial that do not exhibit during the open label titration period one or more unacceptable adverse events to the drug for inclusion in the clinical trial; randomizing selected subjects into a first group to receive the drug and a second group to receive placebo; permitting an adjustment of the amount of drug administered to subjects in the first group for a period of time during the clinical trial; and fixing the amount of drug administered to the subjects in the first group during the clinical trial after the period of time has ended.

Methods are provided for conducting a double-blind placebo controlled clinical trial by administering to subjects an amount of a drug used for treatment and/or alleviation of pain which may induce one or more adverse events in the subjects over an open label titration period prior to the clinical trial; selecting subjects for the clinical trial that do not exhibit during the open label titration period one or more unacceptable adverse events to the drug for inclusion in the clinical trial; randomizing selected subjects into a first group to receive the drug and a second group to receive placebo; and permitting an adjustment of the amount of drug administered to subjects in the first group for the duration of the clinical trial.

Methods are provided for conducting a double-blind placebo controlled clinical trial, the method comprising, a first phase comprising, administering to subjects an amount of a drug used for treatment and/or alleviation of pain which may induce one or more adverse events in the subjects over an open label titration period, and selecting subjects that do not exhibit one or more unacceptable adverse events to the drug for the clinical trial; a second phase comprising, randomizing subjects selected in the first phase into at least one first group to receive the drug and at least one second group to receive a placebo; optionally or additionally a third phase comprising, increasing or decreasing the dosage of medication administered to subjects in the first group; and optionally or additionally a fourth phase comprising, fixing the dosage of drug administered to the subjects in the first group.

Methods are provided for doing business by selecting subjects for inclusion in a clinical trial that do not exhibit one or more unacceptable adverse events in response to an amount (e.g., the highest amount) within the range of amounts of drug used for treatment and/or alleviation of pain administered during an open label titration period and seeking regulatory approval of the drug.

Methods are provided for doing business by selecting subjects for inclusion in a subsequent double-blind treatment period of the clinical trial that do not exhibit one or more unacceptable adverse events in response to an amount (e.g., the highest amount) within the range of amounts of drug used for treatment and/or alleviation of pain administered during an open label titration period; randomizing the selected subjects into at least two groups for the clinical trial, wherein the first group in the clinical trial receives drug and the second group in the clinical trial receives placebo; and seeking regulatory approval of the drug.

Methods are also provided for doing business by selecting subjects for the clinical trial that do not exhibit during the open label titration period one or more unacceptable adverse events to the drug used for treatment and/or alleviation of pain for inclusion in the clinical trial; randomizing selected subjects into at least one first group to receive the drug and at least one second group to receive placebo; permitting an adjustment of the dosage of medication administered to subjects in the first group for a period of time; fixing the dosage of drug administered to the subjects in the first group after the period of time has ended; and seeking regulatory approval of the drug.

Methods are also provided for doing business by selecting subjects for the clinical trial that do not exhibit during the open label titration period one or more unacceptable adverse events to the drug used for treatment and/or alleviation of pain for inclusion in the clinical trial; randomizing selected subjects into at least one first group to receive the drug and at least one second group to receive placebo; permitting an adjustment of the dosage of medication administered to subjects in the first group for the duration of the clinical trial; and seeking regulatory approval of the drug.

Methods are provided for doing business by selecting subjects for the clinical trial that do not exhibit during the open label titration period one or more unacceptable adverse events to the drug used for treatment and/or alleviation of pain for inclusion in the clinical trial; randomizing selected subjects into a first group to receive the drug and a second group to receive placebo; permitting an adjustment of the amount of drug administered to subjects in the first group for a period of time during the clinical trial; fixing the amount of drug administered to the subjects in the first group during the clinical trial after the period of time has ended; and seeking regulatory approval of the drug.

Methods are provided for doing business by selecting subjects for the clinical trial that do not exhibit during the open label titration period one or more unacceptable adverse events to the drug used for treatment and/or alleviation of pain for inclusion in the clinical trial; randomizing selected subjects into a first group to receive the drug and a second group to receive placebo; permitting an adjustment of the amount of drug administered to subjects in the first group for the duration of the clinical trial; and seeking regulatory approval of the drug.

Methods are provided for doing business by conducting a clinical trial with a first phase comprising, selecting subjects for the clinical trial that do not exhibit during the open label titration period one or more unacceptable adverse events to the drug used for treatment and/or alleviation of pain for inclusion in the clinical trial; a second phase comprising, randomizing subjects selected in the first phase into at least one first group to receive the drug and at least one second group to receive a placebo; optionally or additionally a third phase comprising, increasing or decreasing the dosage of medication administered to subjects in the first group; optionally or additionally a fourth phase comprising, fixing the dosage of drug administered to the subjects in the first group; and seeking regulatory approval of the drug.

Methods are provided for doing business by selecting subjects for a clinical trial that do not exhibit adverse events to a drug used for treatment and/or alleviation of pain by administering to subjects a range of amounts from low to high of a drug over an open label titration period to induce one or more adverse events in the subjects; selecting subjects for inclusion in a clinical trial that do not exhibit one or more unacceptable adverse events in response to an amount (e.g., the highest amount) within the range of amounts of drug administered during the open label titration period and seeking regulatory approval of the drug.

Methods are provided for doing business by using subjects in a clinical trial that do not exhibit adverse events to a drug used for treatment and/or alleviation of pain by administering to subjects a range of amounts from low to high of a drug over an open label titration period to induce one or more adverse events in the subjects; selecting subjects for inclusion in the clinical trial that do not exhibit one or more unacceptable adverse events in response to an amount (e.g., the highest amount) within the range of amounts of drug administered during the open label titration period; randomizing the selected subjects into at least two groups for the clinical trial, wherein the first group in the clinical trial receives drug and the second group in the clinical trial receives placebo; and seeking regulatory approval of the drug.

Methods are also provided for doing business by using subjects in a clinical trial that do not exhibit adverse events to a drug used for treatment and/or alleviation of pain by administering to subjects an amount of a drug which may induce one or more adverse events in a subject over an open label titration period; selecting subjects that do not exhibit one or more unacceptable adverse events to the drug for the clinical trial; randomizing selected subjects into at least one first group to receive the drug and at least one second group to receive placebo; permitting an adjustment of the dosage of medication administered to subjects in the first group for a period of time; fixing the dosage of drug administered to the subjects in the first group after the period of time has ended; and seeking regulatory approval of the drug.

Methods are also provided for doing business by using subjects in a clinical trial that do not exhibit adverse events to a drug used for treatment and/or alleviation of pain by administering to subjects an amount of a drug which may induce one or more adverse events in a subject over an open label titration period; selecting subjects that do not exhibit one or more unacceptable adverse events to the drug for the clinical trial; randomizing selected subjects into at least one first group to receive the drug and at least one second group to receive placebo; permitting an adjustment of the dosage of medication administered to subjects in the first group for the duration of the clinical trial; and seeking regulatory approval of the drug.

Methods are provided for doing business by using subjects in a clinical trial that do not exhibit adverse events to a drug used for treatment and/or alleviation of pain by administering to subjects an amount of a drug which may induce one or more adverse events in a subject over an open label titration period prior to the clinical trial; selecting subjects for the clinical trial that do not exhibit during the open label titration period one or more unacceptable adverse events to the drug for inclusion in the clinical trial; randomizing selected subjects into a first group to receive the drug and a second group to receive placebo; permitting an adjustment of the amount of drug administered to subjects in the first group for a period of time during the clinical trial; fixing the amount of drug administered to the subjects in the first group during the clinical trial after the period of time has ended; and seeking regulatory approval of the drug.

Methods are provided for doing business by using subjects in a clinical trial that do not exhibit adverse events to a drug used for treatment and/or alleviation of pain by administering to subjects an amount of a drug which may induce one or more adverse events in a subject over an open label titration period prior to the clinical trial; selecting subjects for the clinical trial that do not exhibit during the open label titration period one or more unacceptable adverse events to the drug for inclusion in the clinical trial; randomizing selected subjects into a first group to receive the drug and a second group to receive placebo; permitting an adjustment of the amount of drug administered to subjects in the first group for the duration of the clinical trial; and seeking regulatory approval of the drug.

Methods are provided for doing business by using subjects in a clinical trial that do not exhibit adverse events to a drug used for treatment and/or alleviation of pain, comprising: a first phase comprising: administering to subjects an amount of a drug which may induce one or more adverse events in a subject over an open label titration period, and selecting subjects that do not exhibit one or more unacceptable adverse events to the drug for the clinical trial; a second phase comprising, randomizing subjects selected in the first phase into at least one first group to receive the drug and at least one second group to receive a placebo; optionally or additionally a third phase comprising, increasing or decreasing the dosage of medication administered to subjects in the first group; optionally or additionally a fourth phase comprising, fixing the dosage of drug administered to the subjects in the first group; and seeking regulatory approval of the drug.

This disclosure is further illustrated by the following examples which are provided to facilitate the practice of the disclosed methods. These examples are not intended to limit the scope of the disclosure in any way.

### EXAMPLES

### Example 1

### Evaluation of the Efficacy and Safety of an Opioid

A clinical trial of an exemplary opioid is conducted. The study drug is a long acting oral formulation of oxycodone. The clinical trial is conducted in subjects with moderate to severe chronic pain due to osteoarthritis of the hip or knee. A primary objective of the clinical trial is to study the efficacy and safety of the study drug in these subjects. A secondary objective of the clinical trial is to compare quality of life measures in these subjects with moderate to severe chronic pain due to osteoarthritis of the hip or knee who receive the study drug as compared with those who receive placebo.

For this clinical trial, a multicenter, randomized, double-blind, placebo-controlled, phase III study is conducted in approximately four hundred subjects with moderate to severe chronic pain due to osteoarthritis of the hip or knee. The study evaluated the efficacy and safety of the study drug relative to placebo over a twelve week double-blind treatment period. Subjects that met eligibility criteria enter a two week open-label titration phase in which subjects are administered 5 mg study drug titrated up to 20 mg study drug. Approximately four-hundred subjects are selected that tolerate 20 mg study drug (e.g., no unacceptable adverse events). The selected subjects are randomized in a 1:1 ratio to receive the study drug or placebo with dose adjustments allowed during the first four weeks of the double-blind treatment period. The randomization schedule is generated using a permuted block algorithm and randomly allocated study medication to randomization numbers. The randomization numbers are assigned sequentially through a central IVRS system as subjects are entered into the study.

Prior to the open-label titration period, subjects are put through a four to ten day washout period during which they stopped taking all pain medication other than acetaminophen (500 mg every four to six hours PRN [a maximum of 3000 mg/day] was permitted). A daily diary (via touch tone phone system) is utilized to record each of the subjects overall pain intensity (PI) each day during the washout period.

Subjects are permitted to enter the open-label titration period if the mean value of the diary PI over the last two days of the washout period (Baseline PI) is ≧5; if IVRS diary compliance was ≧75%; and, if the subject continues to meet all inclusion/exclusion criteria. Baseline functional assessments are conducted using the Short Form 12 Question Health Survey (SF-12) (Table 1 below) and the Western Ontario and MacMaster Universities Osteoarthritis Index (WOMAC) (Table 2 below).

1. TABLE 1
The SF-12v2 ™ Health Survey

Instructions for Completing the Questionnaire
Please answer every question. Some questions may look like others, but each one is different. Please
take the time to read and answer each question carefully by filling in the bubble that best represents your
response.
EXAMPLE
This is for your review. Do not answer this question. The questionnaire begins with the section Your
Health in General below.
For each question you will be asked to fill in a bubble in each line:
1. How strongly do you agree or disagree with each of the following statements?

| | | Strongly | | | | Strongly |
|---|---|---|---|---|---|---|
| | | agree | Agree | Uncertain | Disagree | disagree |
| a) | I enjoy listening to | ◯ | | ◯ | ◯ | ◯ |
| | music. | | | | | |
| b) | I enjoy reading | | ◯ | ◯ | ◯ | ◯ |
| | magazines. | | | | | |

Please begin answering the questions now.

Your Health in General

1. In general, would you say your health is:

| Excellent | Very good | Good | Fair | Poor | |
|---|---|---|---|---|---|
| ◯₁ | ◯₂ | ◯₃ | ◯₄ | ◯₅ | GH1 |

2. The following questions are about activities you might do during a typical day. Does your
health now limit you in these activities? If so, how much?

| | | Yes, | | No, not | |
|---|---|---|---|---|---|
| | | limited | Yes, limited | limited | |
| | | a lot | a little | at all | |
| a) | Moderate activities, such as | ◯₁ | ◯₂ | ◯₃ | PF02 |
| | moving a table, pushing a | | | | |
| | vacuum cleaner, bowling, or | | | | |
| | [symbol] | | | | |
| b) | Climbing several flights of stairs | ◯₁ | ◯₂ | ◯₃ | PF04 |

3. During the past week, how much of the time have you had any of the following problems
with your work or other regular daily activities as a result of your physical health?

| | | All of | Most of | Some of | A little of | None of | |
|---|---|---|---|---|---|---|---|
| | | the time | the time | the time | the time | the time | |
| a) | Accomplished | ◯₁ | ◯₂ | ◯₃ | ◯₄ | ◯₅ | RP2 |
| | less than you | | | | | | |
| | would like | | | | | | |
| b) | Were limited in the | ◯₁ | ◯₂ | ◯₃ | ◯₄ | ◯₅ | RP3 |
| | kind of work or | | | | | | |
| | other activities | | | | | | |

4. During the past week, how much of the time have you had any of the following problems
with your work or other regular daily activities as a result of any emotional problems
(such as feeling depressed or anxious)?

| | | All of | | | | | |
|---|---|---|---|---|---|---|---|
| | | the | Most of | Some of | A little of | None of | |
| | | time | the time | the time | the time | the time | |
| a) | Accomplished | ◯₁ | ◯₂ | ◯₃ | ◯₄ | ◯₅ | RE2 |
| | less than you | | | | | | |
| | would like | | | | | | |
| b) | Did work or | ◯₁ | ◯₂ | ◯₃ | ◯₄ | ◯₅ | RE3 |
| | other activities | | | | | | |
| | less carefully | | | | | | |
| | than usual | | | | | | |

5. During the past week, how much did pain interfere with your normal work (including both
work outside the home and housework)?

| Not at all | A little bit | Moderately | Quite a bit | Extremely | |
|---|---|---|---|---|---|
| ◯₁ | ◯₂ | ◯₃ | ◯₄ | ◯₅ | BP2 |

6. These questions are about how you feel and how things have been with you during the
past week. For each question, please give the one answer that comes closest to the way
you have been feeling. How much of the time during the past week. . .

| | | All of the | Most of | Some of | A little of | None of | |
|---|---|---|---|---|---|---|---|
| | | time | the time | the time | the time | the time | |
| a) | have you felt | ◯₁ | ◯₂ | ◯₃ | ◯₄ | ◯₅ | MH3 |
| | calm and | | | | | | |
| | peaceful? | | | | | | |
| b) | did you have a | ◯₁ | ◯₂ | ◯₃ | ◯₄ | ◯₅ | VT2 |
| | lot of energy? | | | | | | |
| c) | have you felt | ◯₁ | ◯₂ | ◯₃ | ◯₄ | ◯₅ | MH4 |
| | downhearted and | | | | | | |
| | depressed? | | | | | | |

7. During the past week, how much of the time has your physical health or emotional
problems interfered with your social activities (like visiting friends, relatives, etc.)?

| | | | A little of | None of | |
|---|---|---|---|---|---|
| All of the | Most of the | Some of the | the | the | |
| time | time | time | time | time | |
| ◯₁ | ◯₂ | ◯₃ | ◯₄ | ◯₅ | SF2 |

THANK YOU FOR COMPLETING THIS QUESTIONNAIRE! [symbol]
indicates data missing or illegible when filed

During the open-label titration period, subjects were titrated from 5 mg study drug to 20 mg study drug over two weeks as follows:

| Week | Day | Dose of Study Drug |
|---|---|---|
| Week 1 | Days 1-3 | 5 mg |
| Open-Label | Days 4-7 | 10 mg |
| Week 2 | Days 1-3 | 15 mg |
| Open-Label | Days 4-7 | 20 mg |

Subjects are instructed to take a dose of study drug with breakfast and with dinner, to administer doses at least eight hours apart and to take the study drug with meals. Additionally, subjects record their overall PI every twenty-four hours by calling in their daily diary information (via touch tone phone) immediately before bedtime.

At the end of each week during the open-label titration period, subjects return to the study center and opioid toxicity assessments, adverse events, concomitant medications, drug accountability, and vital signs are performed.

At the end of the open-label titration period, subjects are enrolled in the double-blind placebo-controlled study if the subjects are able to tolerate 20 mg study drug (e.g., no unacceptable adverse events) and if IVRS diary compliance is ≧75%. Approximately 400 subjects selected from the open-label titration period are randomized in a 1:1 ratio to receive the study drug or placebo. Randomization of the subjects is stratified by both baseline PI (<7.5 vs. ≧7.5) and by the average PI over the last two days of the open-label titration period (<5 vs. ≧5). Thus, there were four groups for the stratification at randomization (e.g., <7.5, <5; <7.5, ≧5; ≧7.5, <5; and ≧7.5, ≧5). During the first four weeks of the double-blind treatment period, subjects are titrated (up or down) to analgesic effect. At the conclusion of four weeks, the dose is fixed for an additional 8 weeks.

The patient characteristics of the 558 patients enrolled in the open label study are shown in Table 3.

TABLE 3
PATIENT CHARACTERISTICS
OPEN-LABEL TITRATION PERIOD
ANALYSIS POPULATION: OPEN-LABEL SAFETY POPULATION

| | OXY BID | |
|---|---|---|
| | (N = 558) | |
| AGE (YEARS) | | |
| MEAN (SD) | 58.9 | (8.23) |
| MEDIAN | 59.1 | |
| MIN, MAX | 40.4, 75.7 | |
| N | 558 | |
| <=60 | 301 | (53.9%) |
| >60 | 257 | (46.1%) |
| SEX | | |
| FEMALE | 387 | (69.4%) |
| MALE | 171 | (30.6%) |
| TOTAL | 558 | (100.0%) |
| ETHNICITY | | |
| HISPANIC OR LATINO | 35 | (6.3%) |
| NOT HISPANIC OR LATINO | 521 | (93.4%) |
| RACE | | |
| AMERICAN INDIAN OR ALASKA | 5 | (0.9%) |
| NATIVE | | |
| ASIAN | 1 | (0.2%) |
| BLACK OR AFRICAN AMERICAN | 83 | (14.9%) |
| NATIVE HAWAIIAN OR OTHER | 0 | (0.0%) |
| PACIFIC ISLANDER | | |
| WHITE | 469 | (84.1%) |
| HEIGHT (CM) | | |
| MEAN (SD) | 167.5 | (9.58) |
| MEDIAN | 165.6 | |
| MIN, MAX | 137.2, 208.3 | |
| N | 556 | |
| WEIGHT (KG) | | |
| MEAN (SD) | 94.2 | (19.55) |
| MEDIAN | 93.8 | |
| MIN, MAX | 50.4, 136.2 | |
| N | 558 | |
| PRIOR OPIOID USE WITHIN 30 DAYS OF | | |
| FIRST DOES OF OPEN-LABEL STUDY | | |
| DRUG | | |
| YES | 152 | (27.2%) |
| NO | 406 | (72.8%) |
| TARGET JOINT | | |
| HIP | 122 | (21.9%) |
| KNEE | 436 | (78.1%) |
| WASHOUT PERIOD ACETAMINOPHEN | | |
| USAGE | | |
| YES | 532 | (95.3%) |
| NO | 26 | (4.7%) |
| SCREENING CLINIC PI | | |
| MEAN (SD) | 7.0 | (1.40) |
| MEDIAN | 7.0 | |
| MIN, MAX | 4.0, 10.0 | |
| N | 558 | |
| BASELINE PI | | |
| MEAN (SD) | 7.5 | (1.33) |
| MEDIAN | 7.5 | |
| MIN, MAX | 5.0, 10.0 | |
| N | 558 | |
| <7.5 | 255 | (45.7%) |
| >=7.5 | 303 | (54.3%) |
| PRE-RANDOMIZATION PI | | |
| MEAN (SD) | 5.3 | (2.15) |
| MEDIAN | 5.5 | |
| MIN, MAX | 0.0, 10.0 | |
| N | 412 | |
| <5 | 145 | (26.MCNI0%) |
| >=5 | 267 | (47.8%) |

NOTE:
OPEN-LABEL SAFETY POPULATION - ALL PATIENTS WHO TAKE AT LEAST ONE DOSE OF STUDY MEDICATION IN OPEN-LABEL PERIOD.

All subjects enrolled in the open-label titration period received study drug BID as shown in Table 4. Subjects that tolerated the study drug were randomized to receive study drug BID or placebo BID for the remainder of the clinical trial.

TABLE 4
ENROLLMENT AND RANDOMIZATION STATUS

| | PLACEBO BID | OXY BID | TOTAL |
|---|---|---|---|
| OPEN-LABEL SAFETY [1] | | 558 | 558 |
| DOUBLE-BLIND SAFETY [2] | 207 | 205 | 412 |
| ITT[3] | 207 | 203 | 410 |

[1] OPEN-LABEL SAFETY POPULATION - ALL PATIENTS WHO TAKE AT LEAST ONE DOSE OF STUDY MEDICATION IN OPEN-LABEL PERIOD.
[2] DOUBLE-BLIND SAFETY POPULATION - ALL PATIENTS WHO TAKE AT LEAST ONE DOSE OF STUDY MEDICATION IN DOUBLE-BLIND PERIOD.
[3]INTENT TO TREAT POPULATION - ALL RANDOMIZED PATIENTS WHO TAKE ANY STUDY MEDICATION AND HAVE AT LEAST ONE POST-RANDOMIZATION PAIN INTENSITY (PI) ASSESSMENT.

Causes of early termination from study drug BID during the open-label titration period are shown in Table 5. Out of the 146 subjects that terminated during the open label titration period 124 terminated due to adverse events. This constituted 22.2% of the total population of 558 subjects that enrolled in open-label period.

TABLE 5
TERMINATION FROM STUDY DRUG DURING THE
OPEN-LABEL TITRATION PERIOD ANALYSIS
POPULATION: OPEN-LABEL SAFETY POPULATION

| | OXY BID | |
|---|---|---|
| | (N = 146) | |
| DID THE PATIENT TERMINATE STUDY DRUG | | |
| EARLY? | | |
| NO | 0 | (0.0%) |
| YES | 146 | (26.2%) |
| INADEQUATE PAIN RELIEF | 4 | (0.7%) |
| ADVERSE EVENT | 124 | (22.2%) |
| PROTOCOL VIOLATION | 10 | (1.8%) |
| INAPPROPRIATE ENROLLMENT | 5 | |
| NEED FOR PROHIBITED MEDICATION | 0 | |
| OTHER | 5 | |
| PATIENT REQUEST UNRELATED TO STUDY | 5 | (0.9%) |
| OTHER | 3 | (0.5%) |

NOTE:
OPEN-LABEL SAFETY POPULATION - ALL PATIENTS WHO TAKE AT LEAST ONE DOSE OF STUDY MEDICATION IN OPEN-LABEL PERIOD.
NOTE:
THIS TABLE IS FOR OPEN-LABEL SAFETY PERIOD - ONLY PATIENTS WHO EARLY TERMINATED DURING OPEN-LABEL TITRATION.

The types of adverse events and their incidences reported by the subjects that terminated during the open-label titration period are shown in Table 6. The most frequent of these adverse events (AEs) were those commonly associated with opioid medications: dizziness, constipation, dry mouth, nausea, vomiting, somnolence, and pruritis.

TABLE 6
ADVERSE EVENTS CAUSING DISCONTINUATION
OF STUDY MEDICATION DURING THE OPEN-LABEL
TITRATION PERIOD [1]
ANALYSIS POPULATION: OPEN-LABEL SAFETY POPULATION

| | NUMBER (%) |
|---|---|
| | OF PATIENTS |
| | REPORTING |
| | EVENTS |
| SYSTEM ORGAN CLASS | OXY BID |
| PREFERRED TERM | (N = 558) |
| GASTROINTESTINAL DISORDERS | 65 (11.6%) |
| ABDOMINAL PAIN UPPER | 3 (0.5%) |
| CONSTIPATION | 13 (2.3%) |
| DIARRHOEA | 2 (0.4%) |
| DRY MOUTH | 1 (0.2%) |
| NAUSEA | 45 (8.1%) |
| STOMACH DISCOMFORT | 2 (0.4%) |
| VOMITING | 10 (1.8%) |
| GENERAL DISORDERS AND ADMINISTRATION | 14 (2.5%) |
| SITE CONDITIONS | |
| ASTHENIA | 1 (0.2%) |
| CHEST PAIN | 1 (0.2%) |
| FATIGUE | 9 (1.6%) |
| IRRITABILITY | 1 (0.2%) |
| OEDEMA | 1 (0.2%) |
| OEDEMA PERIPHERAL | 1 (0.2%) |
| PAIN | 1 (0.2%) |
| PYREXIA | 1 (0.2%) |
| INFECTIONS AND INFESTATIONS | 1 (0.2%) |
| SINUSITIS | 1 (0.2%) |
| INVESTIGATIONS | 1 (0.2%) |
| HEPATIC ENZYME INCREASED | 1 (0.2%) |
| METABOLISM AND NUTRITION DISORDERS | 1 (0.2%) |
| ANOREXIA | 1 (0.2%) |
| MUSCULOSKELLETAL AND CONNECTIVE | 3 (0.5%) |
| TISSUE DISORDERS | |
| ARTHRIALGIA | 1 (0.2%) |
| MYALGIA | 1 (0.2%) |
| PAIN IN EXTREMITY | 1 (0.2%) |
| NERVOUS SYSTEM DISORDER | 68 (12.2%) |
| DISTURBANCE IN ATTENTION | 2 (0.4%) |
| DIZZINESS | 24 (4.3%) |
| DYSARTHRIA | 4 (0.7%) |
| HEADACHE | 8 (1.4%) |
| LETHARGY | 3 (0.5%) |
| MEMORY IMPAIRMENT | 1 (0.2%) |
| SCIATICA | 1 (0.2%) |
| SEDATION | 1 (0.2%) |
| SOMNOLENCE | 41 (7.3%) |
| PSYCHIATRIC DISORDERS | 21 (3.8%) |
| ABNORMAL DREAMS | 1 (0.2%) |
| AGITATION | 1 (0.2%) |
| ANXIETY | 1 (0.2%) |
| CONFUSIONAL STATE | 11 (2.0%) |
| DEPRESSION | 1 (0.2%) |
| DISORIENTATION | 1 (0.2%) |
| EUPHORIC MOOD | 1 (0.2%) |
| HALLUCINATION | 1 (0.2%) |
| HALLUCINATION, AUDITORY | 1 (0.2%) |
| HALLUCINATION, VISUAL | 1 (0.2%) |
| INSOMNIA | 1 (0.2%) |
| LIBIDO DECREASED | 1 (0.2%) |
| MENTAL STATUS CHANGES | 3 (0.5%) |
| MOOD SWINGS | 1 (0.2%) |
| PERSONALITY CHANGE | 1 (0.2%) |
| REPRODUCTIVE SYSTEM AND BREAST | 1 (0.2%) |
| DISORDERS | |
| ERECTILE DYSFUNCTION | 1 (0.2%) |
| RESPIRATORY, THORACIC AND MEDIASTINAL | 3 (0.5%) |
| DISORDERS | |
| COUGH | 2 (0.4%) |
| DYSPNOEA | 1 (0.2%) |
| SKIN AND SUBCUTANEOUS TISSUE | 19 (3.4%) |
| DISORDERS | |
| HYPERHIDROSIS | 4 (0.7%) |
| PRURITUS | 14 (2.5%) |
| RASH | 2 (0.4%) |
| SWELLING FACE | 1 (0.2%) |
| VASCULAR DISORDERS | 3 (0.5%) |
| HOT FLUSH | 1 (0.2%) |
| HYPOTENSION | 1 (0.2%) |
| ORTHOSTATIC HYPOTENSION | 1 (0.2%) |

NOTE:
OPEN-LABEL SAFETY POPULATION - ALL PATIENTS WHO TAKE AT LEAST ONE DOSE OF STUDY MEDICATION IN OPEN-LABEL PERIOD.
[1] ADVERSE EVENT START DATE IS BETWEEN THE FIRST DOSE DATE OF STUDY MEDICATION IN THE OPEN-LABEL TITRATION PERIOD THROUGH THE LAST DOSE DATE OF STUDY MEDIATION IN THE OPEN-LABEL TITRATION PERIOD.

The characteristics of the 412 subjects enrolled in the twelve week double-blind treatment period are shown in Table 7. Thus, 412 subjects that tolerated study drug administered during the open-label titration period continued in the double-blind treatment period.

TABLE 7
PATIENT CHARACTERISTICS
12-WEEK DOUBLE-BLIND PERIOD
ANALYSIS POPULATION: DOUBLE-BLIND SAFETY POPULATION

| | PLACEBO BID | | OXY BID | | TOTAL | |
|---|---|---|---|---|---|---|
| | (N = 207) | | (N = 205) | | (N = 412) | |
| AGE (YEARS) | | | | | | |
| MEAN (SD) | 58.5 | (8.44) | 58.0 | (7.86) | 58.2 | (8.15) |
| MEDIAN | 58.5 | | 57.5 | | 57.7 | |
| MIN, MAX | 40.4, 75.7 | | 40.4, 75.0 | | 40.4, 75.7 | |
| N | 207 | | 205 | | 412 | |
| <=60 | 119 | (57.5%) | 119 | (58.0%) | 238 | (57.8%) |
| >60 | 88 | (42.5%) | 86 | (42.0%) | 174 | (42.2%) |
| SEX | | | | | | |
| FEMALE | 141 | (68.1%) | 147 | (71.7%) | 288 | (69.9%) |
| MALE | 66 | (31.9%) | 58 | (28.3%) | 124 | (30.1%) |
| TOTAL | 207 | (100.0%) | 205 | (100.0%) | 412 | (100.0%) |
| ETHNICITY | | | | | | |
| HISPANIC OR LATINO | 17 | (8.2%) | 4 | (2.0%) | 21 | (5.1%) |
| NOT HISPANIC OR LATINO | 187 | (91.3%) | 200 | (97.6%) | 389 | (94.4%) |
| RACE | | | | | | |
| AMERICAN INDIAN OR ALASKA | 2 | (1.0%) | 3 | (1.5%) | 5 | (1.2%) |
| NATIVE | | | | | | |
| ASIAN | 0 | (0.0%) | 0 | (0.0%) | 0 | (0.0%) |
| BLACK OR AFRICAN | 33 | (15.9%) | 36 | (17.6%) | 69 | (16.7%) |
| AMERICAN | | | | | | |
| NATIVE HAWAIIAN OR OTHER | 0 | (0.0%) | 0 | (0.0%) | 0 | (0.0%) |
| PACIFIC ISLANDER | | | | | | |
| WHITE | 171 | (82.6%) | 167 | (81.5%) | 338 | (82.0%) |
| HEIGHT (CM) | | | | | | |
| MEAN (SD) | 168.0 | (9.98) | 166.6 | (10.14) | 167.3 | (10.07) |
| MEDIAN | 165.1 | | 165.1 | | 165.1 | |
| MIN, MAX | 147.3, 193.0 | | 137.2, 208.3 | | 137.2, 208.3 | |
| N | 207 | | 204 | | 411 | |
| WEIGHT (KG) | | | | | | |
| MEAN (SD) | 96.7 | (19.77) | 94.4 | (20.05) | 95.6 | (19.92) |
| MEDIAN | 97.6 | | 96.2 | | 97.2 | |
| MIN, MAX | 50.4, 136.2 | | 50.8, 136.2 | | 50.4, 136.2 | |
| N | 207 | | 205 | | 412 | |
| TARGET JOINT | | | | | | |
| HIP | 43 | (20.8%) | 46 | (22.4%) | 89 | (21.6%) |
| KNEE | 164 | (79.2%) | 159 | (77.6%) | 323 | (78.4%) |
| WASHOUT PERIOD ACETAMINOPHEN | | | | | | |
| USAGE | | | | | | |
| YES | 201 | (97.1%) | 196 | (95.6%) | 397 | (96.4%) |
| NO | 6 | (2.9%) | 9 | (4.4%) | 15 | (3.6%) |
| SCREENING CLINIC PI | | | | | | |
| MEAN (SD) | 7.0 | (1.38) | 7.1 | (1.48) | 7.0 | (1.43) |
| MEDIAN | 7.0 | | 7.0 | | 7.0 | |
| MIN, MAX | 5.0, 10.0 | | 4.0, 10.0 | | 4.0, 10.0 | |
| N | 207 | | 205 | | 412 | |
| BASELINE PI | | | | | | |
| MEAN (SD) | 7.6 | (1.36) | 7.6 | (1.35) | 7.6 | (1.35) |
| MEDIAN | 7.5 | | 7.5 | | 7.5 | |
| MIN, MAX | 5.0, 10.0 | | 5.0, 10.0 | | 5.0, 10.0 | |
| N | 207 | | 205 | | 412 | |
| <7.5 | 90 | (43.5%) | 89 | (43.4%) | 179 | (43.4%) |
| >=7.5 | 117 | (56.5%) | 116 | (56.6%) | 233 | (56.6%) |
| PRE-RANDOMIZATION PI | | | | | | |
| MEAN (SD) | 5.4 | (2.11) | 5.2 | (2.19) | 5.3 | (2.15) |
| MEDIAN | 5.5 | | 5.5 | | 5.5 | |
| MIN, MAX | 0.0, 10.0 | | 0.0, 10.0 | | 0.0, 10.0 | |
| N | 207 | | 205 | | 412 | |
| <5 | 72 | (34.8%) | 73 | (35.6%) | 145 | (35.2%) |
| >=5 | 135 | (65.2%) | 132 | (64.4%) | 267 | (64.8%) |

NOTE:
DOUBLE-BLIND SAFETY POPULATION - ALL PATIENTS WHO TAKE AT LEAST ONE DOSE OF STUDY MEDICATION IN DOUBLE-BLIND PERIOD.

All subjects begin dosing at 20 mg study drug BID (or placebo BID). Subjects in the placebo group are titrated down over the first two weeks of the double-blind treatment period to prevent the emergence of opioid withdrawal symptoms (15 mg BID for the first 3 days of Week 1, 10 mg BID for the remainder of Week 1, and 5 mg BID for Week 2). Subjects return to the clinic at the end of each week (±1 day) for the first four weeks and then every two weeks (14-16 days) for the remainder of the double-blind fixed-dose treatment period.

During the 12-week treatment period, subjects record their PI every 24 hours in their daily diary immediately before their bedtime dose. In addition, subjects record adverse events and date/time of taking the study medication in the daily diary. At each study center visit, the investigator collects, additional data, including quality of analgesia, pain control, the SF-12 Health Survey, the WOMAC Osteoarthritis Index and a global assessment of study medication. Unscheduled study center visits are allowed throughout the study for treatment of adverse events. Adverse events, opioid toxicity assessments, drug accountability, concomitant medication and vital signs are performed at each scheduled study center visit.

Subjects are allowed to increase their dose of study drug during study center visits at the end of Weeks 1, 2, and 3 of the double-blind treatment period if the following criteria are met: (1) the subject tolerates the study drug (no unacceptable adverse events); the subject's Pain Intensity (PI) score is >2; and (3) both the Investigator and the subject agree that dose should be increased. Subjects may choose not to increase dose of study drug if they had a PI>2 that they found acceptable. Subjects may also decrease their dose of study medication during the first four weeks of the double-blind treatment period if they had unacceptable adverse events. At the end of Week 4 the final dosage of study drug is fixed for the remainder of the double-blind fixed-dose treatment period.

The following titration schedule outlines the allowed dose increments for subjects requiring dose adjustments of study drug. The maximum allowed dose for study drug is 40 mg BID (total daily dose 80 mg). Subjects may not skip a dose increment if a dose was titrated up or down. Titrating up more than one dose increment may lead to study drug-related adverse events, and titrating down more than one dose increment may lead to inadequate analgesia. Subjects are dispensed one or two blister packets of study drug at each study center visit.

Study Drug 5 mg BID
Study Drug 10 mg BID
Study Drug 15 mg BID
Study Drug 20 mg BID
Study Drug 30 mg BID
Study Drug 40 mg BID

At the conclusion of the 12-week double-blind treatment period, subjects are gradually tapered off of study drug over a period of 0 to 15 days, depending on the final fixed dose, to prevent the emergence of opioid withdrawal symptoms as follows:

| | | Days 0-3 | Days 4-6 | Days 7-9 | Days 10-12 | Days 13-15 |
|---|---|---|---|---|---|---|
| Final Fixed | | Taper | Taper | Taper | Taper | Taper |
| Dose | | Period | Period | Period | Period | Period |
| 40 | mg BID | 30 mg BID | 20 mg BID | 15 mg BID | 10 mg BID | 5 mg BID |
| 30 | mg BID | 20 mg BID | 15 mg BID | 10 mg BID | 5 mg BID | — |
| 15 or 20 | mg BID | 10 mg BID | 5 mg BID | — | — | — |

| | | |
|---|---|---|
| 5 or 10 | mg BID | No taper required |

Also at the conclusion of the clinical trial, subjects are educated about the possibility of study drug withdrawal symptoms. Any subject experiencing symptoms of study drug withdrawal may return to the study center for an additional visit for treatment. Subjects are required to return to the study center for a post-treatment follow-up visit approximately one week (±two days) after the final dose of study drug.

Safety of the study drug is evaluated by vital signs (blood pressure, heart rate, respiratory rate and temperature), physical examinations, electrocardiograms (EKGs), clinical laboratory tests, adverse event monitoring, and opioid toxicity assessments. Subjects may return to the study center in-between scheduled visits for treatment of study drug-related adverse events and investigators are encouraged to treat opioid-related adverse events (e.g., constipation, nausea, vomiting, dizziness, and pruritis) as soon as they occur to avoid unnecessary dropouts from the study.

Inclusion criteria are as follows:
(1) Males and females who are ≧40 and ≦75 years of age;
(2) Subject had moderate to severe pain in one or more hip or knee joint(s) for at least three months prior to the Screening Visit due to osteoarthritis as demonstrated by clinical and radiographic evidence according to the American College of Rheumatology (ACR) criteria for the diagnosis of osteoarthritis of the hip or knee;
(3) Subject has moderate to severe pain in the hip or knee joint(s) while taking ≧4 days/week every week for the past four weeks prior to the Screening Visit one or more of the following types of oral analgesic medication(s): NSAIDs, COX-2 inhibitors, tramadol, opioids;
(4) Subject had received: no opioids within 72 hours of the Screening Visit and either: no opioids or an average daily opioid dose equivalent of oxycodone ≦20 mg or tramadol ≦200 mg within one week prior to the Screening Visit; or a daily opioid dose equivalent of oxycodone (>20 mg and ≦80 mg) or tramadol >200 mg within one week prior to the Screening Visit and had undergone an opioid taper prior to study entry;
(5) Subject had a pain intensity score of ≧5 on an 11-point numerical scale at the Screening Visit;
(6) Subject had a mean daily diary overall pain intensity of ≧5 on an 11-point numerical scale during the last two days of the washout period (Baseline PI; calculated by IVRS);
(7) Subject completed daily telephone diary pain intensity assessments for ≧75% days (calculated by IVRS) during the washout period and during the open-label titration period;
(8) Subject completed the open-label titration period and is able to tolerate study drug at 20 mg BID;
(9) Subject agreed to refrain from taking any pain medications other than study drug during the study period. [Aspirin (up to 325 mg/day) is permitted for cardiovascular prophylaxis if at a stable dose one month prior to the Screening Visit. Acetaminophen is allowed during the washout period only];
(10) Subject must be ambulatory;
(11) Females who are postmenopausal, physically incapable of childbearing, or practicing an acceptable method of birth control. Acceptable methods of birth control include surgical sterilization, hormonal contraceptives, or double-barrier methods (condom or diaphragm with a spermicidal agent or intrauterine device [IUD]). If practicing an acceptable method of birth control, a negative urine pregnancy test result has been obtained prior to starting the open-label titration period; and
(12) Subject is able to understand and cooperate with study procedures, has access to a touch-tone telephone at home, and has signed a written informed consent form prior to any study procedures.

Exclusion criteria for subjects are as follows:

(1) Subject had a positive urine drug screen at the Baseline Visit;

(2) Subject had received a daily opioid dose equivalent of oxycodone >80 mg for 4 or more days/week during the week prior to the initial Screening Visit;

(3) Subject had pain in the hip(s) or knee(s) caused by conditions other than osteoarthritis, e.g., malignancy, gout, inflammatory disease such as rheumatoid arthritis, fibromyalgia, recent trauma within the past six months, or infection;

(4) Subject had a history of Paget's disease, or autoimmune diseases associated with arthritis (e.g. rheumatoid arthritis, lupus, Sjogren's are exclusionary diagnoses);

(5) Subject had major surgery within three months prior to the Screening Visit or has surgery planned during the proposed study period;

(6) Subject had received oral, intra-articular, or parenteral corticosteroid therapy within one month prior to the Screening Visit;

(7) Subject had received an intra-articular injection of hyaluronic acid in the hip or knee within six months prior to the Screening Visit;

(8) Subject weighs more than 300 lbs or less than 100 lbs;

(9) Subject was pregnant or breast-feeding;

(10) Subject had received an epidural or intrathecal infusion of any analgesic medication(s) within one month prior to the Screening Visit;

(11) Subject had severe impairment of pulmonary function, hypercarbia, hypoxia, cor pulmonale, sleep apnea syndrome, severe/uncontrolled asthma, chronic obstructive pulmonary disease, or a history of respiratory depression;

(12) Subject had a history of gastric bypass surgery; any gastric or small intestine surgery leading to malabsorption; or any disease that causes clinical malabsorption;

(13) Subject had unstable cardiac disease (e.g. inadequately controlled hypertension, congestive heart failure, a history of myocardial infarction within the previous year); or subject has any health condition(s) that pose a significant health risk in the event of opioid withdrawal;

(14) Subject had started, stopped, or changed the dose of the following medications within four weeks prior to the Screening Visit: monoamine oxidase inhibitors, tricyclic antidepressants, serotonin reuptake inhibitors or other antidepressants; gabapentin, pregabalin, and glucosamine/chondroitin;

(15) Subject had started or stopped physical therapy, transcutaneous electrical nerve stimulation, chiropractic, osteopathic, acupuncture, or other complementary treatment within four weeks prior to the Screening Visit or is expected to undergo any changes in these therapies during the study;

(16) Subject had received high doses of sedatives, hypnotics or tranquilizers that may, in the opinion of the investigator, increase the risk of opioid toxicity;

(17) Subject had received phenothiazines or other agents that compromise vasomotor tone. (Promethazine is allowed);

(18) Subject had a history of alcohol or drug abuse within the past 5 years;

(19) Subject had a medical illness/condition, psychiatric illness, and/or abnormal diagnostic finding that would interfere with the completion of the study, confound the results of the study, or pose risk to the subject;

(20) Subject had a history of leukemia, lymphoma, myeloproliferative disease, multiple myeloma, or metastatic cancer; subject has a history of prostate, breast, thyroid or lung cancer within five years of study entry; or subject has a history of any other localized malignancy within two years of study entry. (Subjects with treated localized prostate, breast, thyroid or lung cancer without recurrence for ≧five years, any other treated localized malignancy without recurrence for ≧2 years, or a history of curative treatment of basal or squamous cell carcinoma of the skin are not excluded);

(21) Subject had a history of an allergic reaction or hypersensitivity to any of the study medications or structurally similar compounds: oxycodone, morphine, hydromorphone, hydrocodone, levorphanol, pentazocine, codeine, etc. or acetaminophen;

(22) Subject has AST, ALT, or alkaline phosphatase >2 times the upper limit of normal; hematocrit <30%; creatinine ≧1.8; or ESR >20 from the Screening Visit;

(23) Subject had previously received the study drug;

(24) Subject had participated in another investigational drug trial or therapeutic trial within 30 days of the Screening Visit;

(25) Subject had taken analgesic medication (other than acetaminophen) during the washout period prior to enrollment; or subject has taken any analgesic medication (other than study drug) during the open-label titration period prior to randomization.

The physical descriptions of the drugs used for the study are as follows. The drugs are available in capsules containing study drug or placebo. The study drug capsules are available in 5 mg, 10 mg, 15 mg 20 mg, 30 mg and 40 mg. Dosage strengths come in four different sized capsules. The 5 mg dosage strength comes in Size 4 (small) capsules, the 10 mg dosage strength comes in Size 2 (medium) capsules, the 15 and 20 mg dosage strengths come in Size 1 (large) capsules, and the 30 and 40 mg dosage strengths come in Size 00 (extra large) capsules. Placebo capsules are indistinguishable from the study drug capsules. For the 4- to 10-day washout period, a container of acetaminophen (500 mg caplets) is dispensed at the Screening Visit in a sufficient quantity for dosing up to six caplets per day. The investigational drug supplies are in capsule dosage forms containing study drug BID or placebo BID. All of the capsule dosage forms are indistinguishable from one another to facilitate blinding.

One or two containers of acetaminophen (APAP) are dispensed at the Screening Visit for the 4- to 10-day washout period. A commercially available source of acetaminophen tablets (500 mg) is supplied. A single panel label is applied to commercially sourced plastic bottles of acetaminophen to obscure the original dosing instructions.

Throughout the study, investigational drug supplies (study drug) are dispensed in child-resistant blister cards. Each blister card contains a one-week (Days 1-7) supply of study drug as well as extra study drug (Days 8-10) to allow for flexibility in planning return clinic visits. Blister cards for the double-blind taper period contain a 6- to 15-day supply of study drug, depending on the subject's final fixed dose. The extra study drug must remain intact within its original packaging so that it may be returned at each clinic visit.

During the open-label titration period, capsules are arranged on each blister card by day and contain two capsules per day. For the first week, the blister card contains 20 capsules (Days 1-10) consisting of Size 4 and Size 2 capsules; the first three days will be 5 mg capsules and the remaining days will be 10 mg capsules. The Week 2 blister card contains Size 1 capsules; the first three days will be 15 mg capsules and the remaining days are 20 mg capsules.

During the first two weeks of the double-blind treatment period, the blister card contains 40 capsules. Capsules are arranged on each blister card by day (Days 1-10) and contain four capsules per day. All subjects are instructed to take two capsules with breakfast and two capsules with dinner for the first two weeks of the double-blind treatment period. The purpose of this change in the number of capsules is to allow placebo subjects to be titrated off of PTI-821 to prevent opioid withdrawal while still maintaining the double-blind.

During the remainder of the double-blind treatment period up until the end of the fixed-dose treatment period, the blister cards contain 20 capsules. Capsules are arranged on each blister card by days (Days 1-10) and contain two capsules per day. Subjects are instructed to take one capsule of study drug BID for the remainder of the study.

At the conclusion of the 12-week fixed dose portion of the double-blind treatment period, subjects who have been on study drug for at least four weeks (including the open-label titration period) are tapered off of study drug over a period of 0-15 days, depending on the final fixed dose. Tapering is performed in a blinded fashion. Subjects taking 40 mg BID require a 15 day taper, subjects taking 30 mg BID require a 12 day taper, subjects taking 15, or 20 mg BID require a 6 day taper, and subjects taking 10 or 5 mg BID do not require a taper. Each blister card contains 12, 24, or 30 capsules. Capsules are arranged on each blister card by days and contain two capsules per day. Subjects are instructed to take one capsule of study drug BID until there are no capsules remaining in the blister card.

The label on each blister card contains a unique kit number that is assigned to patients at weekly or biweekly intervals. An Interactive Voice Response System (IVRS) provides assignment of kit numbers.

One blister card is dispensed for each week of the open-label titration period and for the first four weeks of the double-blind fixed-dose treatment period. Two blister cards are dispensed at the biweekly visits for the remainder of the 12-week double-blind fixed-dose treatment period. If the subject requires a taper, one blister card is dispensed at the end of treatment visit.

Each blister card has a label consisting of two parts. One part remains attached to the kit and the other is a tear-off label, which is adhered onto the appropriate Case Report Form (CRF). The information included on the label is in accordance with local requirements. All blister cards, empty or containing unused capsules, are saved for final disposition by the sponsor or designee.

The study procedures are as follows. Prior to any study-related activities, written informed consent was signed and dated by the subject. Clinical examinations are performed that comprise the standard-of-care evaluations routinely performed as part of ongoing care for subjects with moderate to severe chronic pain due to osteoarthritis of the hip or knee. Pain assessments are performed by assessing: (1) Pain Intensity, (2) Quality of Analgesia, (3) Pain Control, and (4) Global Assessment of Study Medication.

Pain Intensity is assessed by prompting the subject with the question, “How would you rate your overall pain intensity at this time?”, and the PI score was recorded in the clinic. Pain Intensity was also assessed by prompting the subject with the question, “How would you rate your overall pain intensity during the past 24 hours?”, and a daily PI diary score was recorded by the subject at bedtime. For both Pain Intensity prompts, the response is scored on an 11-point numerical scale (0=no pain and 10=severe pain).

Quality of Analgesia is assessed weekly at clinic visits. The subject is prompted with the question, “How would you rate the quality of your pain relief at this time?”, and responses were selected from poor, fair, good, very good, and excellent.

Pain Control is also assessed weekly at clinic visits. The subject is prompted with the question, “During the past week, how would you describe your pain control during the course of each day?” Responses were selected from: Pain was controlled for (1) a few hours or less each day; (2) several hours each day; (3) most of each day; and (4) throughout each day.

Global Assessment of Study Medication is also assessed weekly at clinic visits. The subject was prompted with the question, “How would you rate the study medication you received this past week? (Please consider the quality of your pain relief, your side effects, your activity level, your mood and sense of well-being, etc. in this evaluation)”. Responses are selected from poor, fair, good, very good, and excellent.

Additionally, functional assessments are conducted with the SF-12 Health Survey (see Table 1) and the WOMAC Osteoarthritis Index (see Table 2).

Safety procedures include taking vital signs (blood pressure, respiratory rate, heart rate and temperature), physical examinations, EKGs, clinical laboratory tests, adverse events, opioid toxicity assessments and the assessment of opiate withdrawal symptoms. The opioid toxicity assessment included: (a) CNS review by assessing for (1) confusion, altered mental state, (2) excessive drowsiness, lethargy, stupor, (3) slurred speech (new onset), (4) respiratory, (5) hypoventilation, shortness of breath, apnea, (6) hypoxia, hypercarbia; and (b) cardiac review by assessing for bradycardia, hypotension, and shock. Subjects experiencing opioid toxicity, as determined by the Investigator, must be early terminated from the study and must stop taking study drug. If subjects must be terminated from the study, the Early Drug Termination assessments and the Post-Treatment Follow-Up Visit must be completed. Subjects who are early terminated because of opioid toxicity should not undergo a taper; study drug must be stopped immediately in order to allow the blood levels of study drug to decline. Sites must monitor subjects who early terminate due to opioid toxicity closely, with a minimum of daily telephone calls until resolution of symptoms. If symptoms of opioid withdrawal occur, the subject may return to the study center for treatment.

Opioid toxicity assessments are performed at clinic visits to evaluate dose escalation and to evaluate whether it is safe for the patient to continue on the study medication. Opioid toxicity is distinct from opioid-related adverse events in that it signifies an unacceptable safety risk to the patient to remain on study medication (e.g. risk of overdose from respiratory depression). Opioid toxicity assessments must be conducted by an MD or DO Principal Investigator/Sub-Investigator. The assessments include a review of the following:

Opioid Toxicity Assessment

| Organ System | Signs/Symptoms |
|---|---|
| Central Nervous | Confusion, altered mental status |
| System* | Excessive drowsiness, lethargy, stupor |
| | Slurred speech (new onset) |
| Respiratory | Apnea |
| | Decreased respiratory rate (<8/minute) or |
| | cyanosis |
| Cardiac | Bradycardia, hypotension, or shock |

Alterations in mental status must be present in order to make the diagnosis of opioid toxicity. Subjects experiencing opioid toxicity, as determined by the Investigator, must be early terminated from the study and must stop taking study drug. If subjects must be terminated from the study, the Early Drug Termination assessments and the Post-Treatment Follow-Up Visit must be completed. Subjects who are early terminated because of opioid toxicity should not undergo a taper; study drug must be stopped immediately in order to allow the blood levels of study drug to decline. Study centers must monitor patients who early terminate due to opioid toxicity closely, with a minimum of daily telephone calls until resolution of symptoms. If symptoms of opioid withdrawal occur, the patient may return to the study center for treatment.

Additionally, adverse events are monitored throughout the course of the study. An adverse event (AE) is any undesirable event that occurs to a participant during the course of the study, whether or not that event is considered study drug-related. Examples include:

(1) Any treatment-emergent signs and symptoms (e.g., events that are marked by a change from the subject's baseline/entry status such as an increase in severity or frequency of pre-existing abnormality or disorder);

(2) All reactions from the study drug, an overdose, abuse of drug, withdrawal phenomena, sensitivity or toxicity to the study drug;

(3) Apparently unrelated illnesses;

(4) Injury or accidents (Note: if a medical condition is known to have caused the injury or accident, the medical condition and the accident should be reported as two separate medical events, for example, for a fall secondary to dizziness, both “dizziness” and “fall” should be recorded separately); and/or

(5) Extensions or exacerbations of symptoms, subjective subject-reported events, new clinically significant abnormalities in clinical laboratory, physiological testing or physical examination.

All adverse events, whether or not related to the study drug, are fully and completely documented on the adverse event page of the case report form (CRF) and in the subject's clinical chart. In the event that a subject is withdrawn from the study because of an adverse event, it must be recorded on the CRF. However, the withdrawn subject must be followed and treated by the Investigator until the abnormal parameter or symptom has resolved or stabilized.

The Investigator must report all directly observed adverse events and all spontaneously reported adverse events. At each visit the Investigator will ask the subject a non-specific question (e.g., “Have you noticed anything different since your last visit?”) to assess whether any adverse events have been experienced since the last report or visit. Adverse events (AEs) are identified and documented on the adverse event CRF in appropriate medical terminology. The severity and the relationship to the study drug is determined and reported on the CRF.

In addition to reporting the medication on the Concomitant Medication CRF, the investigator or designee needs to question whether an adverse event has occurred when intermittent or as needed (“prn”) use of any medication (and specifically any newly prescribed medication) were taken during treatment period for conditions worsened from or not present before enrollment into study. This may indicate the occurrence of an adverse event that may also need to be recorded on the adverse event CRF.

The severity of each adverse event is characterized and then classified into one of three clearly defined categories as follows:

(1) Mild—the adverse event does not interfere in a significant manner with the subject's normal functioning level. It may be an annoyance,
(2) Moderate—the adverse event produces some impairment of functioning, but is not hazardous to health. It is uncomfortable or an embarrassment, or
(3) Severe—the adverse event produces significant impairment of functioning or incapacitation and is a definite hazard to the subject's health.

These three categories are based on the Investigator's clinical judgment, which in turn depends on consideration of various factors such as the subject's report, the physician's observations and the physician's prior experience. The severity of the adverse event is recorded in the appropriate section of the adverse event CRF.

The relationship of each adverse event to the study drug is classified into one of three defined categories as follows:

(1) Unlikely—a causal relationship between the adverse event and the study drug is unlikely,

(2) Possible—a causal relationship between the adverse event and the study drug is possible, or

(3) Probable—a causal relationship between the adverse event and the study drug is probable. For example, the adverse event is a common adverse event known to occur with the pharmacological class the study drug belongs to; or the adverse event abated on study drug discontinuation and reappeared upon rechallenge with the study drug.

These three categories are based on the Investigator's clinical judgment, which in turn depends on consideration of various factors such as the subject's report, the timing of the adverse event in relationship to study drug administration/discontinuation, the physician's observations and the physician's prior experience. The relationship of the adverse event to the study drug is recorded in the appropriate section of the adverse event CRF.

Any adverse event that suggests a significant hazard, contraindication, side effect or precaution is defined as a Serious Adverse Event (SAE). An SAE includes (but is not limited to) an experience occurring at any dose that results in any of the following outcomes:

(1) Death;

(2) A life-threatening event (i.e., the subject is at immediate risk of death from the reaction as it occurs). “Life-threatening” does not include an event that, had it occurred in a more serious form, might have caused death. For example, drug-induced hepatitis that resolved without evidence of hepatic failure would not be considered life-threatening even though drug-induced hepatitis can be fatal;

(3) Subject hospitalization (hospital admission, not an emergency room visit) or prolongation of existing hospitalization;

(4) A persistent or significant disability/incapacity (i.e., a substantial disruption of the subject's ability to carry out normal life functions); and/or

(5) A congenital anomaly/birth defect.

In addition, medical and scientific judgment must be exercised in deciding whether other situations are to be considered an SAE (e.g., important medical events that may not be immediately life-threatening or result in death, but may jeopardize the subject or may require medical or surgical intervention to prevent one of the other outcomes listed in the definition above). Examples of such medical events include: allergic bronchospasm requiring intensive treatment in an emergency room or at home, or blood dyscrasias or new-onset seizures that do not result in subject hospitalization.

An unexpected adverse event is one for which the specificity or severity is not consistent with the current Investigator's Brochure. For example, hepatic necrosis would be unexpected (by virtue of greater severity) if the Investigator's Brochure only listed elevated hepatic enzymes or hepatitis. Similarly, cerebral thromboembolism and cerebral vasculitis would be unexpected (by virtue of greater specificity) if the Investigator's Brochure only listed cerebral vascular accidents.

The reporting of SAEs by the Sponsor to Regulatory Authorities (e.g., Food and Drug Administration (FDA)) is a regulatory requirement. Each Regulatory Agency has established a timetable for reporting SAEs based upon established criteria. Likewise, it is the responsibility of the Principal Investigator to report SAEs to their ECs/IRBs immediately.

All SAEs must be reported immediately (within 24 hours of learning of the event) by telephone to the Sponsor or Contract Research Organization (CRO) designee. Any additional information, if collected, can be reported to the Sponsor (or CRO designee) as a follow-up to the initial report.

In the case of a death or other SAE that has occurred within 30 days after receiving study drug, the Principal Investigator must also report such an event within 24 hours of being notified.

In the event of any SAE (other than death), the subject is instructed to contact the study physician (Principal Investigator or designee) using the phone number provided in the Informed Consent Form. All subjects that experience a SAE are seen by a Principal Investigator or designee as soon as feasible following the report of an SAE.

At the first visit, pre-enrollment screening is performed. The following assessments are conducted at Visit 1 (Screening Visit):

(1) Obtain written informed consent from the subject;

(2) Screen subject's PI (must be ≧5 to continue the screening process);

(3) Review inclusion and exclusion criteria;

(4) Obtain subject's detailed medical history including concomitant medications taken one month prior to the Screening Visit;

(5) Complete subject's physical examination including height, weight and vital signs;

(6) Perform an EKG (QTc interval);

(7) Obtain blood samples for clinical laboratory tests;

(8) Obtain urine sample for urinalysis;

(9) Perform urine pregnancy test for all women of childbearing potential;

(10) Obtain an X-ray of the subject's hip/knee. All subjects must have radiographic evidence of osteoarthritis of the hip or knee according to ACR diagnostic criteria. Subjects who do not have an X-ray report that documents radiographic evidence of osteoarthritis of the hip or knee within the past two years must have an X-ray performed prior to the next (Baseline) visit;

(11) Contact IVRS to obtain a subject identification number and to register the subject for the daily touch-tone phone diary;

(12) Review each section of the diary with the subject and provide written instructions for use of the diary; and

(13) IVRS provides an acetaminophen bottle number and dispense acetaminophen to the subject.

At the conclusion of the visit the subject is given an appointment card for the next study visit.

The study nurse thoroughly reviewed each section of the diary with the subject. The subject is advised to telephone IVRS prior to bedtime each day of the washout period to record their overall PI over the past 24 hours.

At a second visit, four to ten days after the Screening Visit, the subjects return to the study center for completion of the pre-dose assessments (Baseline/Open-Label Titration Visit). This visit includes the following:

(1) Screen the subject's urine sample using a rapid drug screen kit;

(2) Contact IVRS to review the subject's daily diary PI scores from the washout period to verify that: the mean daily overall PI score collected in the diary over the last two days of the washout period is ≧5 (on a scale of 0 to 10) while off all analgesic medications (except acetaminophen), and that the subject completed daily diary PI assessments ≧75% of the days during the washout period;

(3) Collect the bottle of acetaminophen and perform accountability; and,

(4) Review inclusion and exclusion criteria to verify that the subject has radiographic evidence of OA of hip or knee within the past two years (Inclusion #2) according to ACR diagnostic criteria and that the clinical laboratory test results from the Screening Visit are without significant clinical abnormalities (Exclusion #22) (e.g., the urine pregnancy test is negative (if required; Inclusion #11).

If subjects fail to meet inclusion/exclusion criteria, they are considered screening failures. Subjects meeting all study entry criteria continue in the screening process and receive the following assessments:

(1) Obtain subject's interim medical history (to identify any changes from the Screening Visit);

(2) Obtain the subject's vital signs; and

(3) Review and record the subject's concomitant medications.

Subjects who have no clinically significant changes in interim medical history and vital signs that would prohibit them from entering the study and who have not taken any prohibited medications (or stopped, started, or changed the dose of restricted medications) can enter the open-label titration period. The following assessments will be performed:

(1) WOMAC Osteoarthritis Index (select target joint to be assessed throughout the study; Appendix I). The subject must select a target joint which is defined as the hip or knee joint with osteoarthritis causing the subject the most pain. The subject must refer to the same joint throughout the study when completing the WOMAC; and

(2) SF-12 Health Survey.

Once these assessments and procedures are completed, subjects are enrolled in the open-label titration period. IVRS is telephoned to obtain a blister card for the subject for Week 1 of the open-label titration period and one blister card of study medication is dispensed to the subject with 3 days of 5 mg BID and 7 days of 10 mg BID. The blister card of study drug has a two-part clinical label. The tear-off portion of the label is removed and attached to the CRF.

An appointment card is provided to the subject before he/she leaves the clinic for the next visit. The subject is instructed to take one capsule of study drug with breakfast and one capsule of study drug with dinner. The subjects are further instructed that they must administer doses with meals at least eight hours apart and the subjects are informed that taking the study drug on an empty stomach may lead to insufficient pain relief.

The touch-tone daily diary is used to record overall PI in the past 24 hours immediately prior to bedtime.

At a third visit (End of Week 1 of the Open-Label Titration Period), subjects return to the study center for completion of the pre-dose assessments (Baseline/Open-Label Titration Visit). This visit includes the following assessments:

(1) Perform opioid toxicity assessments (must be performed by MD or DO Principal Investigator/Sub-Investigator);

(2) Contact IVRS to review diary (overall daily PI and subject compliance);

(3) Record new/changed adverse events and concomitant medications. Subjects may experience opioid-related adverse events during the titration period. Subjects are to be instructed that mild opioid-related AEs (feeling drowsy, nausea, vomiting, pruritis, dizziness) often go away within 24-48 hours of dose titration, with the exception of constipation. Subjects may return for additional visits to receive treatment of opioid-related AEs. Investigators are encouraged to treat opioid-related adverse events as soon as they occur to avoid subject discomfort/early termination;

(4) Collect study medication from previous week and account for used/unused supplies;

(5) Obtain the subject's vital signs;

(6) Telephone IVRS in order to assign subjects one blister card for the remaining week of the open-label titration period; and

(7) Dispense the blister card of study medication to the subject with 3 days of 15 mg BID and 7 days of 20 mg BID. The blister card of study drug has a two-part clinical label. Remove the tear-off portion of the label and attach it to the CRF;

An appointment card is provided to the subject before he/she leaves the clinic for the next visit. The subject is instructed to take one capsule of study drug with breakfast and one capsule of study drug with dinner. The subjects are further instructed that they must administer doses with meals at least eight hours apart and the subjects are informed that taking the study drug on an empty stomach may lead to insufficient pain relief.

The touch-tone daily diary is used to record overall PI in the past 24 hours immediately prior to bedtime.

At a fourth visit (End of the Open-Label Titration Period/Randomization Visit or Early Drug Termination from Open-Label Titration Period Visit), subjects return to the study center at the end of the week (7-8 days after the last visit). In addition, any subject who early terminates from the open-label titration period and took at least one dose of study medication must return for follow-up safety assessments. The following assessments are performed:

(1) Opioid toxicity assessments (must be performed by MD or DO Principal Investigator/Sub-Investigator);

(2) Contact IVRS to review diary (overall daily PI and subject compliance);

(3) Verify that the subject completed daily diary assessments ≧75% of the days during the open-label titration period (Inclusion #7);

(4) Record new/changed adverse events and concomitant medications;

(5) Verify that subject is able to tolerate AEs (if any) associated with administration of study drug 20 mg (Inclusion #8);

(6) Verify that the subject did not take any prohibited analgesics during the open-label titration period (Exclusion #25); and the subject did not start, stop or change the dose of any of the medications listed in Exclusion #14;

(7) Collect study medication from previous week and account for used/unused supplies;

(8) Obtain vital signs;

(9) Obtain blood samples for clinical laboratory tests; and

(10) Obtain urine sample for urinalysis.

Subjects who continue to meet all inclusion/exclusion criteria are randomized. Subjects who have early terminated from the open-label titration period require no further assessments at this visit, but must return for the Post-Treatment Follow-Up Visit.

The following assessments are performed on continuing subjects:

(1) WOMAC Osteoarthritis Index (target joint assessed throughout study); and

(2) SF-12 Health Survey.

Once these assessments and procedures are completed, subjects will be randomly assigned to one of the two treatment groups. The following procedures were taken:

(1) Telephone IVRS to assign subjects a randomization number and a blister card for Week 1 of the double-blind treatment period; and

(2) Dispense a blister card of study medication to the subject. The blister card will contain four capsules of study drug per day. The blister card of study drug has a two-part clinical label. Remove the tear-off portion of the label and attach it to the CRF;

An appointment card is provided to the subject before he/she leaves the clinic for the next visit. The subject is instructed to take one capsule of study drug with breakfast and one capsule of study drug with dinner. The subjects are further instructed that they must administer doses with meals at least eight hours apart and the subjects are informed that taking the study drug on an empty stomach may lead to insufficient pain relief.

The touch-tone daily diary is used to record overall PI in the past 24 hours immediately prior to bedtime. The touch-tone diary is used to record the following information: (1) overall PI in the past 24 hours (daily); (2) quality of analgesia (weekly), and (3) global assessment of study medication (weekly). The weekly assessment sections (quality of analgesia and global assessment of study medication) of the touch-tone phone diary are thoroughly reviewed with the subject.

At a fifth visit (End of Week 1 of the Double-Blind Treatment Period (Titration), subjects return to the study center at the end of Week 1 (±one day). The following assessments are performed:

(1) Opioid toxicity assessments (must be performed by MD or DO Principal Investigator/Sub-Investigator);

(2) Contact IVRS to review diary (overall daily PI and subject compliance);

(3) Record new/changed adverse events and concomitant medications;

(4) Collect study medication from previous visit and account for used/unused supplies;

(5) Obtain vital signs;

(6) Determine if a dose increment or dose decrease is required. Dose and adverse events will be evaluated. The dose may be increased to the next dose level (30 mg BID) if the clinic PI is >2, the subject is not experiencing any intolerable adverse events, and the subject and Investigator agree that the dose should be increased. Subjects may choose not to increase dose of study drug if they have a PI>2 that they find acceptable. If a subject reports experiencing any opioid-related adverse events, the Investigator should offer treatment if not resolved (see Appendix F). If the subject or Investigator finds the adverse events unacceptable, the dose will be decreased to the previous level (15 mg BID);

(7) Telephone IVRS in order to assign subjects one blister card; dispense one blister card to the subject. Each blister card has a two-part clinical label. Remove the tear-off portion of the label and attach it to the CRF; and

(8) Review the instructions on the blister card with the subject.

An appointment card is provided to the subject before he/she leaves the clinic for the next visit. The subject is instructed to take one capsule of study drug with breakfast and one capsule of study drug with dinner. The subjects are further instructed that they must administer doses with meals at least eight hours apart and the subjects are informed that taking the study drug on an empty stomach may lead to insufficient pain relief.

The touch-tone daily diary is used to record overall PI in the past 24 hours immediately prior to bedtime. The touch-tone diary is used to record the following information: (1) overall PI in the past 24 hours (daily); (2) quality of analgesia (weekly); and (3) global assessment of study medication (weekly).

At visits 6 to 8 (End of Weeks 2, 3, and 4 of the Double-Blind Treatment Period (Titration)), subjects return to the study center at the end of Weeks 2, 3 and 4 (±one day). The following assessments are performed at each visit:

(1) Perform opioid toxicity assessments (must be performed by MD or DO Principal Investigator/Sub-Investigator);

(2) Contact IVRS to review diary (overall daily PI and subject compliance);

(3) Record new/changed adverse events and concomitant medications;

(4) Collect study medication from previous visit and account for used/unused supplies;

(5) Check vital signs;

(6) Determine if dose adjustment is required (increase allowed only at End of Weeks 1, 2 or 3; decrease allowed at End of Weeks 1, 2, 3 or 4). Dose and adverse events will be evaluated at each visit. The dose may be increased to the next dose level at the End of Weeks 1, 2, or 3 if the clinic PI is >2, the subject is not experiencing any intolerable adverse events, and the subject and Investigator agree that the dose should be increased. Subjects may choose not to increase dose of study drug if they have a PI>2 that they find acceptable. If a subject reports experiencing any opioid-related adverse events, the Investigator should offer treatment if not resolved. If the subject or Investigator finds the adverse events unacceptable, the dose will be decreased to the previous level. The dose may be decreased at the End of Weeks 1, 2, 3, or 4. Subjects are required to remain on the dose of study drug administered at the End of Week 4 for the remainder of the study;

(7) Telephone IVRS in order to assign subjects one or two (End of Week 4) blister cards; and

(8) Dispense one or two (End of Week 4) blister cards to the subject. Each blister card has a two-part clinical label. Remove the tear-off portion of the label and attach it to the CRF.

An appointment card is provided to the subject before he/she leaves the clinic for the next visit. The subject is instructed to take one capsule of study drug with breakfast and one capsule of study drug with dinner. The subjects are further instructed that they must administer doses with meals at least eight hours apart and the subjects are informed that taking the study drug on an empty stomach may lead to insufficient pain relief.

The touch-tone daily diary is used to record overall PI in the past 24 hours immediately prior to bedtime. The touch-tone diary is used to record the following information: (1) overall PI in the past 24 hours (daily); (2) quality of analgesia (weekly); and (3) global assessment of study medication (weekly).

At visits 9 to 11 (End of Weeks 6, 8, and 10 of the Double-Blind Treatment Period (Fixed Dose)), subjects will return to the study center every two weeks (14-16 days after the last visit) for the remainder of the study. Subjects are required to remain on the dose of study drug administered at the End of Week 4. The following assessments are performed at each visit:

(1) Perform opioid toxicity assessments (must be performed by MD or DO Principal Investigator/Sub-Investigator);

(2) Contact IVRS to review diary (overall daily PI and subject compliance);

(3) Record new/changed adverse events and concomitant medications;

(4) Collect study medication from previous visit and account for used/unused supplies;

(5) Check vital signs. If a subject reports experiencing any opioid-related adverse events, the Investigator should offer treatment;

(6) Telephone IVRS in order to assign subjects two blister cards; and

(7) Dispense two blister cards to the subject. Each blister card has a two-part clinical label. Remove the tear-off portion of the label and attach it to the CRF.

An appointment card is provided to the subject before he/she leaves the clinic for the next visit. The subject is instructed to take one capsule of study drug with breakfast and one capsule of study drug with dinner. The subjects are further instructed that they must administer doses with meals at least eight hours apart and the subjects are informed that taking the study drug on an empty stomach may lead to insufficient pain relief.

The touch-tone daily diary is used to record overall PI in the past 24 hours immediately prior to bedtime. The touch-tone diary is used to record the following information: (1) overall PI in the past 24 hours (daily); (2) quality of analgesia (weekly); and (3) global assessment of study medication (weekly).

At visit 12 (End of Week 12 of Double-Blind Treatment Period/Early Drug Termination), subjects return to the study center at either the end of Week 12 (14-16 days after the last visit) or after early drug termination for the following assessments:

(1) perform opioid toxicity assessments (must be performed by MD or DO Principal Investigator/Sub-Investigator);

(2) contact IVRS to review daily diary (overall daily PI and subject compliance);

(3) record new/changed adverse events and concomitant medications;

(4) collect study medication and account for used/unused supplies;

(5) complete physical examination and vital signs;

(6) perform EKG (QTc interval);

(7) obtain blood samples for clinical laboratory tests;

(8) obtain urine sample for urinalysis;

(9) WOMAC osteoarthritis index (target joint assessed throughout the study); and

(10) SF-12 Health Survey.

Subjects may require a taper to prevent opioid withdrawal depending on the duration of treatment with study drug and the final dose of study drug administered during the fixed dose treatment period. Subjects taking 5 or 10 mg BID do not require a taper and are to return to the clinic in approximately one week for a post-treatment follow-up visit. Subjects who early terminate from the study require a taper if they have been on study drug for greater than four weeks (including the open-label titration period) and were on a dose >10 mg of study drug BID at the time of early termination. For subjects requiring a taper, the following procedures are performed:

(1) Telephone IVRS in order to assign subjects a blister card; and

(2) Dispense 1 blister card to the subject. The tear-off portion of the clinical label on the blister card is removed and attached to the CRF. Subjects are given the following blister cards depending on their final fixed dose: Final fixed dose of 40 mg BID, blister card with 15 days of study drug, Final fixed dose of 30 mg BID: blister card with 12 days of study drug, Final fixed dose of 15 or 20 mg BID: blister card with 6 days of study drug, or a Final fixed dose of 5 or 10 mg BID: no taper required.

An appointment card is provided to the subject before he/she leaves the clinic for the next visit to occur one week after the subject's final dose of study medication (up to 22 days). The subject is instructed to take one capsule of study drug with breakfast and one capsule of study drug with dinner. The subjects are further instructed that they must administer doses with meals at least eight hours apart and the subjects are informed that taking the study drug on an empty stomach may lead to insufficient pain relief.

Subjects are educated about the possibility of opioid withdrawal after study drug discontinuation. Subjects are instructed to refrain from taking any opioid-containing medications (including tramadol or combination medications such as Vicodin) during the double-blind taper period and subjects are instructed to contact the study center immediately if severe/intolerable symptoms of opioid withdrawal are experienced. If required, subjects may take non-opioid analgesics.

If a subject experiences intolerable pain during the double-blind taper period in spite of maximal non-opioid analgesic therapy, the Investigator may early terminate the subject from the study and refer for appropriate pain management.

Subjects may telephone sites to request additional visits if they experience opioid-related AEs. Subjects are to be instructed that, with the exception of constipation, mild opioid-related AEs (feeling drowsy, nausea, vomiting, pruritis, dizziness) often go away within 24-48 hours. Subjects may return for additional visits to receive treatment of opioid-related AEs. Investigators are encouraged to treat opioid-related adverse events as soon as they occur to avoid subject discomfort/early termination. The following assessments are performed:

(1) Perform opioid toxicity assessment;

(2) Record new/changed adverse events and concomitant medications;

(3) Obtain vital signs; and

(4) Treat opioid-related AEs (if applicable).

If the subject is experiencing opioid toxicity, the subject must be early terminated from the trial. If the subject is not experiencing opioid toxicity but is experiencing significant opioid-related adverse events, the Investigator is to offer treatment for the following opioid-related AEs: nausea, vomiting, pruritis, dizziness, or constipation. Unscheduled visits for treatment of opioid-related adverse events are allowed throughout the study.

At visit 13 (Post-Treatment Follow-up), subjects return to the study center approximately one week (±two days) after the last dose of study medication for a post-treatment follow-up visit. At this visit, the following assessments are completed:

(1) Collect study medication and account for used/unused supplies for subjects requiring a taper; and

(2) Record new/changed adverse events and concomitant medications.

Subjects could choose to discontinue study drug or study participation at any time, for any reason, specified or unspecified, and without prejudice. If a subject chooses to discontinue study drug early during the open-label titration period, the investigator must request that the subject return to the clinic within 24 hours of stopping the study medication and complete the assessments for early drug termination from the open-label titration period. If a subject chooses to discontinue study drug early during the double-blind treatment period, the investigator must request that the subject return to the clinic within 24 hours of stopping the study medication and complete the End of Week 12/Early Drug Termination assessments. In addition, if the subject has been on study drug for greater than four weeks (including the open-label titration period), the subject is to be tapered off of study drug according to the subject's current dose at the time of discontinuation. Subjects who are early terminated from the study because of opioid toxicity should not undergo a taper and must stop taking study drug immediately.

Subjects must be educated about the possibility of withdrawal after study drug discontinuation. Instruct the subject to contact the study center immediately if severe/intolerable symptoms of opioid withdrawal are experienced. The investigator must also request that the subject complete the Post-Treatment Follow-Up Visit and the double-blind taper period (if applicable) for safety reasons.

The SF-12 evaluations, recorded at baseline and at the end of each week, were scored as described in Ware et al., “SF-12: How to score the SF-12 physical and mental health summary scales.” QualityMetric Inc., Lincoln, R.I., and the Health Assessment Lab, Boston, Mass. (3d Ed. 1998), which is incorporated by reference herein. The summarization and analysis of the WOMAC Osteoarthritis Index were specified in the Statistical Analysis Plan per the WOMAC User Guide, which is obtainable at the WOMAC organization website www.womac.org/contact/index.cfm and incorporated by reference herein.

Adverse events reported were mapped to preferred terms and organ systems using the MedDRA mapping system. Adverse events were associated with weeks according to their onset date. The number and percentage of subjects reporting each event are summarized by treatment group and week.

Treatment groups are examined for differences in the incidence and severity of selected opioid-associated adverse events, including constipation, dizziness, somnolence, headache, pruritus, nausea, vomiting, urinary retention, and bradypnoea. The homogeneity of response between males and females is investigated descriptively.

All subjects that take at least one dose of study medication following randomization and complete at least one post-randomization pain intensity assessment are evaluable for efficacy analyses. All subjects who take at least one dose of oral study medication are evaluable for safety analyses.

The primary efficacy analysis population is the intent-to-treat (ITT) population. The ITT population consists of all randomized subjects who are administered any study medication, have at least one post-randomization PI assessment and are used for efficacy analyses. All subjects who take at least one dose of study medication are used for safety analyses.

Demographic variables and subject characteristics are summarized descriptively by treatment group. Demographic variables include age, weight, height, gender, and race/ethnicity. Baseline characteristics include target joint, mean daily overall PI collected through the IVRS over the last two days of the washout and open-label titration periods, screening clinic PI, washout period acetaminophen usage, and baseline and pre-randomization values of efficacy and quality of life variables. Baseline and post-baseline patient characteristics include study drug administration, prior and concomitant medications, final study drug dose, and opioid use within one month prior to study.

The following endpoints are summarized and analyzed for efficacy analysis:

(1) Daily diary PI score are analyzed as weekly values as follows: For each week, the PI recorded during all days of the week are averaged. Baseline PI is defined as the average PI recorded during the two days immediately prior to the Baseline visit. Pre-randomization PI is defined as the average PI recorded during the two days immediately prior to randomization at the end of the open-label titration period;

(2) Quality of analgesia is assessed and analyzed weekly;

(3) Global assessment of study medication is assessed and analyzed weekly;

(4) WOMAC Osteoarthritis Index is assessed and analyzed at baseline, pre-randomization and at the end of treatment; calculated per the WOMAC User Guide; and

(5) SF-12 is assessed and analyzed at baseline, pre-randomization and at the end of treatment, scored as described in the documentation.

The following endpoints are summarized and analyzed for safety analysis:

(1) Adverse events reported on case report forms are mapped to preferred terms and body systems using the Medical Dictionary for Regulatory Activities (MedDRA) coding dictionary;

(2) The number and percent of subjects reporting each event are summarized during the open-label titration period and by treatment group during the double-blind treatment period. Incidence of adverse events by maximum reported severity are also tabulated. Serious adverse events and adverse events leading to discontinuation are displayed;

(3) Vital signs are summarized descriptively based on actual value, change from baseline, and change from randomization. QTc interval is summarized descriptively based on actual value and change from baseline;

(4) Laboratory data are summarized descriptively based on actual value, change from baseline and in terms of the normal range. Physical examination results are summarized by number and percentage of patients with abnormalities in each body system examined.

For primary analysis of data, the primary efficacy endpoint is the percent change from baseline in pain intensity at the conclusion of the study. The primary efficacy variable is the area under the curve (AUC) for the change in PI from randomization to the end of the Week 12 fixed dose portion of the double-blind treatment period. AUC is determined by linear trapezoidal method. The primary efficacy analysis compares the mean AUC for the study drug treatment group versus the placebo group, using treatment as a factor and pre-randomization PI score as a covariate in an ANCOVA model. Missing data is not imputed. For randomized patients who drop out, whether for adverse events or lack of adequate pain relief or use of rescue medication, only data prior to withdrawal is used. Implicitly AUC assigns zero differences from baseline after withdrawals. The double-blind taper period is not included in the AUC calculation.

For secondary analysis of data, quality of analgesia, global assessment of study medication, WOMAC Osteoarthritis Index, and the SF-12 Health Survey are analyzed. The weekly averaged PI scores are analyzed at the end of each week of titration and at the end of each week of the double-blind fixed dose period. The change and percent change from baseline and from randomization is compared across treatment groups using the same ANCOVA as the primary analysis. In addition, this data is presented by target joint, sex and age.

The quality of analgesia and global assessment of study medication are analyzed as categorical variables using a stratified Cochran-Mantel-HaenszelT (CMH) test with baseline and pre-randomization PI to define the strata. The comparisons across treatment groups are presented overall, and by target joint, sex and age.

The WOMAC Osteoarthritis Index (pain subscale, stiffness subscale, physical function subscale, total score) and SF-12 are analyzed at the end of treatment in terms of change and percent change from randomization. The change and percent change from randomization is compared across treatment groups using the same ANCOVA as the primary analysis. The change and percent change from baseline is also analyzed. In addition, the comparison is made by target joint, sex and age.

AUC is calculated for the change from baseline PI including the two-week open-label titration period for each treatment group using treatment as a factor and baseline PI score as a covariate in an ANCOVA model. AUC is determined by linear trapezoidal method. Comparative analysis will follow the ANCOVA model as the primary analysis.

For the purpose of sample size and power calculations, placebo subjects who complete the study period are assumed to have at least a mean decrease in change from baseline PI of up to 25%. The majority of withdrawals in enrichment designs occur during the open-label titration phase. The assumed withdrawal rate after randomization is 25%.

To design a study with greater than 90% power, with a common standard deviation of 30%, a mean difference of 10% in average AUC in PI requires a sample size of 200 patients per treatment group (400 total) using a 0.05 two-sided significance level.

Unless otherwise indicated, all testing of statistical hypotheses is two-sided, and a difference resulting in a p-value of less than or equal to 0.05 is considered statistically significant.

Causes of early termination from study drug during the double-blind treatment period are shown in Table 8. The majority of subjects who terminated from the trial (10.6% of subjects taking placebo Bib and 21.0% of subjects taking study drug BID) experienced an adverse event. Out of the 145 subjects that terminated during the double-blind period 65 (15.8%) terminated due to adverse events. This constituted (10.6%) of the subjects administered placebo BID and (21.0%) of subjects administered study drug BID.

TABLE 8
TERMINATION FROM STUDY DRUG DURING THE 12-WEEK
DOUBLE-BLIND PERIOD ANALYSIS POPULATION:
DOUBLE-BLIND SAFETY POPULATION

| | PLACEBO BID | | OXY BID | | TOTAL | |
|---|---|---|---|---|---|---|
| | (N = 207) | | (N = 205) | | (N = 412) | |
| DID THE PATIENT TERMINATE STUDY | | | | | | |
| DRUG EARLY? | | | | | | |
| NO | 132 | (63.8%) | 131 | (63.9%) | 263 | (63.8%) |
| YES | 75 | (36.2%) | 70 | (34.1%) | 145 | (35.2%) |
| INADEQUATE PAIN RELIEF | 38 | (18.4%) | 12 | (5.9%) | 50 | (12.1%) |
| ADVERSE EVENT | 22 | (10.6%) | 43 | (21.0%) | 65 | (15.8%) |
| PROTOCOL VIOLATION | 6 | (2.9%) | 7 | (3.4%) | 13 | (3.2%) |
| INAPPROPRIATE | 1 | | 1 | | 2 | |
| ENROLLMENT | | | | | | |
| NEED FOR | 2 | | 2 | | 4 | |
| PROHIBITED MEDICATION | | | | | | |
| OTHER | 3 | | 4 | | 7 | |
| PATIENT REQUEST | 4 | (1.9%) | 8 | (3.9%) | 12 | (2.9%) |
| UNRELATED TO STUDY | | | | | | |
| OTHER | 5 | (2.4%) | 0 | (0.0%) | 5 | (1.2%) |

NOTE:
DOUBLE-BLIND SAFETY POPULATION - ALL PATIENTS WHO TAKE AT LEAST ONE DOSE OF STUDY MEDICATION IN DOUBLE-BLIND PERIOD.

The most frequent adverse events (AEs) reported were those commonly associated with opioid medications: dizziness, constipation, dry mouth, nausea, vomiting, somnolence, and pruritis. Table 9 shows the AEs that caused termination from the clinical trial from randomization through the post-treatment follow-up visit.

TABLE 9
ADVERSE EVENTS CAUSING DISCONTINUATION OF STUDY MEDIATION FROM
RANDOMIZATION THROUGH THE POST-TREATMENT FOLLOW-UP VISIT [1]
ANALYSIS POPULATION: DOUBLE-BLIND SAFETY POPULATION

| | PLACEBO BID | OXY BID | TOTAL |
|---|---|---|---|
| | (N = 207) | (N = 205) | (N = 412) |
| CARDIAC DISORDERS | 0 (0.0%) | 1 (0.5%) | 1 (0.2%) |
| PALPITATIONS | 0 (0.0%) | 1 (0.5%) | 1 (0.2%) |
| GASTROINTESTINAL DISORDERS | 7 (3.4%) | 16 (7.8%) | 23 (5.6%) |
| ABDOMINAL PAIN | 1 (0.5%) | 1 (0.5%) | 2 (0.5%) |
| CONSTIPATION | 1 (0.5%) | 2 (1.0%) | 3 (0.7%) |
| DIARRHEA | 0 (0.0%) | 1 (0.5%) | 1 (0.2%) |
| DRY MOUTH | 0 (0.0%) | 1 (0.5%) | 1 (0.2%) |
| FAECALOMA | 0 (0.0%) | 1 (0.5%) | 1 (0.2%) |
| NAUSEA | 5 (2.4%) | 9 (4.4%) | 14 (3.4%) |
| VOMITING | 2 (1.0%) | 4 (2.0%) | 6 (1.5%) |
| GENERAL DISORDERS AND | 3 (1.4%) | 2 (1.0%) | 5 (1.2%) |
| ADMINISTRATION SITE CONDITIONS | | | |
| ASTHENIA | 1 (0.5%) | 0 (0.0%) | 1 (0.2%) |
| CHEST PAIN | 0 (0.0%) | 1 (0.5%) | 1 (0.2%) |
| CHILLS | 0 (0.0%) | 1 (0.5%) | 1 (0.2%) |
| FATIGUE | 1 (0.5%) | 0 (0.0%) | 1 (0.2%) |
| OEDEMA | 1 (0.5%) | 0 (0.0%) | 1 (0.2%) |
| PYREXIA | 0 (0.0%) | 1 (0.5%) | 1 (0.2%) |
| HEPATOBILIARY DISORDERS | 1 (0.5%) | 0 (0.0%) | 1 (0.2%) |
| CHOLELITHIASIS | 1 (0.5%) | 0 (0.0%) | 1 (0.2%) |
| INFECTIONS AND INFESTATIONS | 0 (0.0%) | 1 (0.5%) | 1 (0.2%) |
| BRONCHITIS | 0 (0.0%) | 1 (0.5%) | 1 (0.2%) |
| INJURY, POISONING AND | 1 (0.5%) | 0 (0.0%) | 1 (0.2%) |
| PROCEDURAL COMPLICATIONS | | | |
| INCISION SITE COMPLICATION | 1 (0.5%) | 0 (0.0%) | 1 (0.2%) |
| INVESTIGATIONS | 1 (0.5%) | 0 (0.0%) | 1 (0.2%) |
| ASPARTATE | 1 (0.5%) | 0 (0.0%) | 1 (0.2%) |
| AMINOTRANSFERASE | | | |
| INCREASED | | | |
| METABOLISM AND NUTRITION | 1 (0.5%) | 2 (1.0%) | 3 (0.7%) |
| DISORDERS | | | |
| ANOREXIA | 0 (0.0%) | 2 (1.0%) | 2 (0.5%) |
| GOUT | 1 (0.5%) | 0 (0.0%) | 1 (0.2%) |
| MUSCULOSKELETAL AND | 2 (1.0%) | 1 (0.5%) | 3 (0.7%) |
| CONNECTIVE TISSUE DISORDERS | | | |
| ARHRALGIA | 1 (0.5%) | 1 (0.5%) | 2 (0.5%) |
| BACK PAIN | 1 (0.5%) | 0 (0.0%) | 1 (0.2%) |
| OSTEOARTHRITIS | 1 (0.5%) | 0 (0.0%) | 1 (0.2%) |
| PAIN IN EXTREMITY | 1 (0.5%) | 0 (0.0%) | 1 (0.2%) |
| NERVOUS SYSTEM DISORDERS | 6 (2.9%) | 11 (5.4%) | 17 (4.1%) |
| DIZZINESS | 3 (1.4%) | 3 (1.5%) | 6 (1.5%) |
| DYSARTHRIA | 0 (0.0%) | 1 (0.5%) | 1 (0.2%) |
| DYSGEUSIA | 0 (0.0%) | 1 (0.5%) | 1 (0.2%) |
| LETHARGY | 1 (0.5%) | 0 (0.0%) | 1 (0.2%) |
| PARAESTHESIA | 0 (0.0%) | 1 (0.5%) | 1 (0.2%) |
| SOMNOLENCE | 1 (0.5%) | 6 (2.9%) | 7 (1.7%) |
| STUPOR | 0 (0.0%) | 1 (0.5%) | 1 (0.2%) |
| TRANSIENT ISCHAEMIC | 0 (0.0%) | 1 (0.5%) | 1 (0.2%) |
| ATTACK | | | |
| TREMOR | 1 (0.5%) | 0 (0.0%) | 1 (0.2%) |
| PSYCHIATRIC DISORDERS | 4 (1.9%) | 8 (3.9%) | 12 (2.9%) |
| AGITATION | 1 (0.5%) | 0 (0.0%) | 1 (0.2%) |
| ANXIETY | 0 (0.0%) | 1 (0.5%) | 1 (0.2%) |
| CONFUSIONAL STATE | 1 (0.5%) | 4 (2.0%) | 5 (1.2%) |
| DEPRESSION | 0 (0.0%) | 2 (1.0%) | 2 (0.5%) |
| INSOMNIA | 1 (0.5%) | 0 (0.0%) | 1 (0.2%) |
| MENTAL STATUS CHANGES | 0 (0.0%) | 2 (1.0%) | 2 (0.5%) |
| MOOD SWINGS | 0 (0.0%) | 1 (0.5%) | 1 (0.2%) |
| PERSONALITY CHANGE | 1 (0.5%) | 0 (0.0%) | 1 (0.2%) |
| SUICIDE ATTEMPT | 0 (0.0%) | 1 (0.5%) | 1 (0.2%) |
| RESPIRATORY, THORACIC AND | 0 (0.0%) | 2 (1.0%) | 2 (0.5%) |
| MEDIASTINAL DISORDERS | | | |
| DYSPNOEA | 0 (0.0%) | 1 (0.5%) | 1 (0.2%) |
| HAEMOPTYSIS | 0 (0.0%) | 1 (0.5%) | 1 (0.2%) |
| SKIN AND SUBCUTANEOUS TISSUE | 2 (1.0%) | 2 (1.0%) | 4 (1.0%) |
| DISORDERS | | | |
| HYPERHIDROSIS | 0 (0.0%) | 1 (0.5%) | 1 (0.2%) |
| PRURITUS | 2 (1.0%) | 1 (0.5%) | 3 (0.7%) |

NOTE:
DOUBLE-BLIND SAFETY POPULATION - ALL PATIENTS WHO TAKE AT LEAST ONE DOSE OF STUDY MEDICATION IN DOUBLE-BLIND PERIOD.
[1] ADVERSE EVENT START DATE IS BETWEEN THE FIRST DOSE OF STUDY MEDICATION IN THE DOUBLE-BLIND PERIOD THROUGH THE DATE OF POST-TREATMENT FOLLOW-UP/STUDY TERMINATION, INCLUSIVE.

The primary efficacy endpoint for the clinical trial was a decrease in pain intensity (AUC) between study drug BID and placebo BID during the twelve week double-blind treatment period. Subjects that received study drug BID demonstrated a statistically significant decrease in their pain intensity-AUC as compared to the subjects that received placebo BID and thus the study met its prospectively defined primary endpoint with a p=0.007 as shown in Table 10.

TABLE 10
PAIN INTENSITY - AUC
12 WEEK DOUBLE-BLIND PERIOD
ANALYSIS POPULATION: INTENT TO TREAT POPULATION

| | PLACEBO BID | OXY BID | TOTAL |
|---|---|---|---|
| | (N = 207) | (N = 203) | (N = 410) |
| AREA UNDER CURVE (AUC) | | | |
| MEAN (SD) | −30.4 (140.38) | −54.9 (122.44) | −42.5 (132.21) |
| MEDIAN | −1.5 | −27.1 | −9.8 |
| MINIMUM, MAXIMUM | −501.8, 370.7 | −683.3, 382.8 | −683.3, 382.8 |
| N | 205 | 201 | 406 |
| MODEL P-VALUES | | | |
| TREATMENT [1] | 0.007 | | |
| PRE-RANDOMIZATION PI [1] | <0.001 | | |

NOTE:
INTENT TO TREAT POPULATION - ALL RANDOMIZED PATIENTS WHO TAKE ANY STUDY MEDICATION AND HAVE AT LEAST ONE POST-RANDOMIZATION PI ASSESSMENT.
NOTE:
THE AREA UNDER THE CURVE (AUC) IS CALCULATED BY THE LINEAR TRAPEZOIDAL METHOD USING CHANGE FROM PRE-RANDOMIZATION PAIN INTENSITY SCORES.
[1] P-VALUES FROM ANCOVA MODEL INCLUDING TREATMENT AS THE MAIN EFFECT AND PRE-RANDOMIZATION PAIN INTENSITY AS A COVARIATE.

A secondary efficacy endpoint for this study was change in pain intensity from baseline at each of the twelve weeks of the double-blind treatment period. In general, the group that received the study drug BID had consistently lower pain intensity scores at each week during the twelve week double-blind treatment period as compared to the group that received placebo BID (see, e.g., at week twelve p=0.024).

Another secondary efficacy endpoint for this study was global assessment. For global assessment, the group that received study drug BID showed a consistently better global assessment at each week during the twelve week double-blind treatment period as compared to the group that received placebo BID (see, e.g., at week twelve p=0.007).

Another secondary efficacy endpoint for this study was quality of analgesia. For quality of analgesia, the group that received study drug BID showed a consistent and greater improvement in the quality of analgesia at each week during the twelve week double-blind treatment period as compared to the group that received the placebo BID (see, e.g., at week twelve p=0.004).

Another secondary efficacy endpoint for this study was SF-12. For SF-12, the group that received study drug BID had a higher value for the physical component score of the SF-12 (see, e.g., at week twelve p=0.003) and for the mental component score of the SF-12 (see, e.g., at week twelve p=0.055) as compared to the group administered placebo BID, wherein higher values correspond to better health or functioning.

Another secondary efficacy endpoint for this study was a functional assessment using WOMAC, including its three subscales for pain, stiffness and physical function. For the stiffness and physical function subscales of the WOMAC, although the values were lower in the group administered study drug BID as compared to the group administered placebo BID, as expected, the differences were not significant (stiffness subscale p=0.366 at week twelve and physical function subscale p=0.221 at week twelve). For the pain subscale of the WOMAC, the values (% change from baseline to week twelve) were significantly lower in the group administered study drug BID as compared to the group administered placebo BID (p=0.023 at week twelve), wherein lower values correspond to better health or functioning.

No drug related safety issues were noted in this study.

### Example 2

### Preparation of Opioid Formulations

Exemplary opioid dosage forms comprising oxycodone are prepared as described herein. For clinical studies as described in Example 1, capsules having different amounts of oxycodone are produced.

Capsule formulations containing oxycodone at various dose levels (5.0, 10.0, 20.0, 30.0 and 40.0 mg/capsule) and matching placebo capsules are prepared.

The components, pharmaceutical grade, and function of each component used to make oxycodone capsules are provided in Table 11 below.

TABLE 11
Components for Oxycodone Capsules

| Component | Function |
|---|---|
| Oxycodone base (micronized) | Active pharmaceutical ingredient |
| Sucrose acetate isobutyrate | Base component |
| Triacetin, USP | Solvent |
| Isopropyl myristate, NF | Solvent |
| Cellulose acetate butyrate, NF/EP, | Polymer additive |
| ethanol washed (grade 381-20 BP) | |
| Hydroxyethyl cellulose, NF | Non-ionic, water soluble polymer |
| Colloidal silicon dioxide, NF | Suspending agent, viscosity |
| | modifier |
| Butylated hydroxytoluene, NF | Antioxidant |
| Hard gelatin capsule | Dosage form |

Two manufacturing processes are used, to prepare capsules comprising oxycodone. The processes are summarized in the flowchart shown below.

The following raw materials were used to create the formulations: Oxycodone base, micronized; Isopropyl Myristate, NF (“IPM”); Colloidal silicon dioxide (CABOSIL™, Cabot Corp) (SiO₂”); Butylated hydroxyl toluene, NF (“BHT”); Hydroxyethyl cellulose, NF (“HEC”); Sucrose Acetate Isobutyrate (Eastman), (“SAIB”); Triacetin USP (“TA”); Cellulose Acetate Butyrate, grade 381-20 BP, ethanol washed (Eastman) (“CAB”); Sodium Lauryl Sulfate NF (“SDS”); and Labrafil M2125 CS (“LAB”).

Two different processes were developed for opioid dosage forms as shown in the flowchart above. In process one, compounding was carried out at a 45 kg scale. In process two, compounding was carried out at 150 kg scale. The same materials were used in both processes but there were some differences. One difference was the order in which ingredients were added during the manufacture in order to enhance mixing and efficiency during the compounding process. For example, in process two, IPM and SiO₂ were added earlier in the process and CAB was added later in the process to lower fluid viscosity during the first part of the compounding process. Another difference in the oral dosage forms used in some of the clinical studies was that the capsules filled from process one were not sealed, while capsules filled from process two were sealed using a liquid encapsulation microspray sealing (LEMS) process from Capsugel. Table 12 shows a manufacturing process and equipment comparison.

TABLE 12
Manufacturing Process and Equipment Comparison
Process and Equipment Information

| Process | | |
|---|---|---|
| Description | Process 1 | Process 2 |
| API Milling | 8-20 kg scale | 28-36 Kg scale |
| (micronization) | Spiral Jet Mill | Spiral Jet Mill |
| | Hosokawa Alpine model 50AS | Hosokawa Alpine Model 50AS |
| Compounding | 45 kg scale | 150 kg scale |
| | Multishaft mixer including | Multishaft mixer including |
| | low shear anchor agitator | low shear anchor agitator |
| | high speed disperser | high speed disperser |
| | high shear rotor-stator | high shear rotor-stator |
| | Charles Ross mixer model | Charles Ross mixer model |
| | VMC 10 | PVM 40 |
| Encapsulation | Hard gelatin capsule filling | Hard gelatin capsule filling |
| | machine | machine |
| | Shionogi encapsulator model | Zanasi encapsulator model |
| | F-40 | 40E |
| Capsule Sealing | None-capsules were not | Capsules sealed with LEMS |
| | sealed | technology |
| | | Capsugel sealing machine |
| | | model LEMS30 |

Compounding for process one was carried out using a Ross VMC-10 Mixer with SLIM. Accordingly, all references to a specific rpm numeric throughout this compounding process correspond to this model. In a first step, sucrose acetate isobutyrate (SAIB) was preheated to 50-65° C. and then added into a compounding vessel with an anchor speed of at 20-40 rpm. The temperature of the product was maintained at 50-60° C. In a second step, triacetin was added into the compounding vessel and mixed at anchor speed of 20-40 rpm and a disperser speed of 700-2000 rpm. The vessel contents were mixed to achieve a uniform solution of SAIB in triacetin. Again, the product temperature was maintained at 50-60° C. In a third step, pre-sieved, cellulose acetate butyrate (CAB) was inducted into the vessel using high shear dispersion during the addition to prevent formation of agglomerates. The vessel contents were mixed with an anchor speed of 20-50 rpm, a rotor stator speed of 700-4500 rpm and a disperser speed of 700-3500 rpm until the CAB was completely dissolved and a clear gel formed. After formation of the clear-gel the vessel contents were mixed for an additional thirty minutes with the same anchor, rotor stator and disperser speeds. In a fourth step, in a separate container, a solution was prepared containing butylated hydroxytoluene (BHT) and approximately 15% portion of isopropyl myristate (IPM). A 10% portion of the IPM may be set aside to be used as a rinse solvent later in the process. The remaining quantity of the IPM-BHT solution was subsequently added to the compounding vessel and mixed to achieve uniformity with an anchor speed of 20-50 rpm and disperser speed of 700-3500 rpm. After formation of a uniform mixture, the vessel contents were mixed for an additional five minutes with the same anchor and disperser speeds. During the additional mixing, the stator was jogged as necessary at 700-1200 rpm. Again, the product temperature was maintained at 50-60° C. In a fifth step, oxycodone was inducted into the compounding vessel and mixed to achieve uniformity with an anchor speed of 20-50 rpm, disperser speed of 700-3500 rpm and a rotor stator speed of 800-4500 rpm. The product temperature was maintained at 55-65° C. The vessel contents were mixed for a minimum of an additional two minutes with the same anchor, disperser and rotor stator speeds. In a sixth step, hydroxyethyl cellulose (HEC) was inducted into the vessel using high shear dispersion during the addition and mixed to achieve a uniform dispersion with an anchor speed of 20-50 rpm, disperser speed of 700-3500 rpm and a rotor stator speed of 800-4500 rpm. The vessel contents were mixed for an additional two minutes with the same anchor, disperser and rotor stator speeds. Again, the product temperature was maintained at 55-65° C. In a seventh step, colloidal silicon dioxide (SiO₂) was inducted with to the vessel using high shear dispersion during the addition and mixed with an anchor speed of 20-50 rpm, disperser speed of 700-3500 rpm and a rotor stator speed of 800-4500 rpm. The vessel contents were mixed for a minimum of an additional two minutes with the same anchor, disperser and rotor stator speeds. Again, the product temperature was maintained at 55-65° C. In an eighth step, IPM was inducted into the vessel and mixed with an anchor speed of 20-50 rpm, disperser speed of 700-2000 rpm and rotor stator speed of 1500-3000 rpm. The vessel contents were continuously mixed with anchor and maintained at 50-60° C. The final compounded mass was de-aerated by vacuum and flushed with nitrogen at 4-5 psig for at least five minutes. The compounded, controlled-release mass was filled into hard gelatin capsules and packaged into unit dose blisters or multidose plastic bottles with child-resistant closures for clinical supply.

Compounding for process two was carried out with a Ross PVM-40 Mixer with SLIM. Accordingly, all references to a specific rpm numeric throughout this compounding procedure correspond to this model. In a first step, sucrose acetate isobutyrate (SAIB) was preheated to 50-65° C. and added to a compounding vessel. In a second step, triacetin was added to the compounding vessel. In a third step, a butylated hydroxytoluene/isopropyl myristate solution was prepared by dispensing a portion of isopropyl myristate (balance of IPM is added in next step) into a separate stainless steel container. Butylated hydroxytoluene was added to the container and the solution was mixed for at least ten minutes until BHT was dissolved. The BHT hydroxytoluene/isopropyl myristate solution was then added to the compounding vessel. In a fourth step, isopropyl myristate was added to the compounding vessel and mixed to homogeneity with an anchor speed of 10-50 rpm and a disperser speed of 1-2550 rpm. The product temperature was maintained at 35-50° C. In a fifth step, colloidal silicon dioxide (SiO₂) was inducted into the compounding vessel and mixed to achieve uniform dispersion with an anchor speed of 10-50 rpm (e.g., 20 rpm), a disperser speed of 1-2550 rpm (e.g., 1000 rpm) and an rotor stator speed of 1-3600 rpm (e.g. 2500 rpm). Again the product temperature was maintained at 35-50° C. The vessel contents were mixed for an additional two to four minutes with the same anchor, disperser and rotor stator speeds. In a sixth step, cellulose acetate butyrate (CAB) was inducted into to the compounding vessel and mixed with an anchor speed of 10-50 rpm (e.g., 20 rpm), a disperser speed of 1-2550 rpm (e.g., 1500 rpm) and a rotor stator speed of 1-3600 rpm (e.g., 3000 rpm). The product temperature was maintained at 40-60° C. The vessel contents were mixed for an additional two to four minutes with the same anchor, disperser and rotor stator speeds. In a seventh step, oxycodone is inducted into the compounding vessel and mixed to achieve a uniform dispersion with an anchor speed of 10-50 rpm (e.g., 20 rpm), a disperser speed of 1-2550 rpm (e.g., 1500 rpm), and an speed of 1-3600 rpm (e.g., 3000 rpm). Again the product temperature was maintained at 40-60° C. The vessel contents were mixed for an additional two to four minutes with the same anchor, disperser and rotor stator speeds. In an eighth step, hydroxyethyl cellulose (HEC) was inducted into the compounding vessel and mixed with an anchor speed of 10-50 rpm (e.g., 20 rpm), a disperser speed of 1-2550 rpm (e.g., 1500 rpm), and a rotor stator speed of 1-3600 rpm (e.g., 3000 rpm). Again the product temperature was maintained at 40-60° C. The vessel contents were mixed for an additional two to four minutes with the same anchor, disperser and rotor stator speeds. The final compounded mass was de-aerated by vacuum at no less than 14 mm Hg for no less than two hours with anchor speed of 10-50 rpm (e.g., 20 rpm) and dispersion speed of 1-2250 rpm (e.g., 1250 rpm). The compounded, controlled-release mass was filled into hard gelatin capsules. Filled capsules were sealed using LEMS (liquid encapsulation microspray sealing) from Capsugel and packaged into unit dose blisters or multidose plastic bottles with child-resistant closures.

The compounded mass prepared by process 2 is encapsulated using a Zanasi Liqui-Fill Encapsulator and sealed using a LEMS30 Capsule Sealer. Initially, the compounded mass is transferred from the Ross PVM-40 Mixer to a Zanasi Hopper. The transfer lines are heated with a heated hose controller to a temperature of 55-65° C. Then, a Zansai Liqui-Fill Encapsulator is readied by adjusting the Stroke Scale until the proper fill weight is obtained and the temperature of the compounded mass for filling is maintained at 60-65° C. Depending on the size of the dosage form capsule, a variety of filling nozzles were designed with varying nozzle diameters (e.g., 1.2-2.0 mm) for use on the Encapsulator. For a 5 mg, 10 mg or 20 mg capsule dosage form, a 1.2 mm diameter nozzle is used. For a 30 mg or 40 mg capsule dosage form, a 1.5 mm diameter nozzle is used. Next, capsules are removed from the Zansai Liqui-Fill Encapsulator into a collection container and sealed using the LEMS30 Capsule Sealer.

In some cases, the oxycodone used in process one or process two was micronized. Micronization of the oxycodone was conducted using a Hosokawa Alpine Spiral Jet Mill. In operation, a feed material comprising a non-micronized opioid is injected into a flat cylindrical grinding chamber, the chamber having nozzles arranged tangentially on a peripheral wall, in the presence of a propellant air pressure and grinding air pressure appropriate for providing the desired flow dynamics within the chamber needed to effect collision of the opioid particles with each other. An appropriate speed and pressure of the propellant air pressure (such as an injector air pressure of 6.8 Bar) and the grinding air pressure (such as 6.2 Bar) is applied such that a particle on particle collision and interaction with the chamber wall results. The injector gas pressure was always approximately 0.3 to 0.7 Bar higher than grinding pressure to obtain constant flow of oxycodone into the spiral jet mill. A micronized particle thus occurs, providing an opioid preparation having a reduced particle size, the particle size being less than about 10μ. The larger particles are held in the mill by centrifugal (mass) force, while the fine, micronized particles leave the mill in an air stream and are collected (drag force). One set of processing parameters that may be used in the methods for preparing a micronized opioid preparation within a jet gas mill, includes, a batch size of 4 kg; injector clearance default of +3 mm; a feed rate of 40 to 50 g/min; a grinding gas pressure of 6.8 Bar and an injector gas pressure of 6.2 Bar.

Immediately following micronization, the micronized oxycodone is packaged in plastic bags with dessicant and then stored in plastic drums to preserve the integrity of the micronized particles. This is necessary to maintain stabilized micronized opioid particle preparations. The micronized opioids, particularly the salt forms such as oxycodone HCl or hydromorphone HCl, are hydroscopic. The immediate packaging with dessication is required to prevent agglomeration and/or fused particles. For example, the micronized oxydocone is placed into a labeled anti-static bag and secured with a cable or twist tie at the open end of the bag. The anti-static bag is placed into a poly bag with a layer of eight-unit, silica gel, printer, Natrasorb® S Tyvek® four-side seal bag desiccant separating the anti-static bag from the poly bag. The label on the anti-static bag is checked to ensure that it is visible through the poly bag and the poly bag is sealed at its open end. The poly bag is placed in a HDPE (high density polyethylene) drum with a layer of eight-unit, silica gel, printer, Natrasorb® S Tyvek® four-side seal bag desiccant separating the poly bag from the drum. A lid is placed on the open end of the drum and secured using a uniquely numbered security locking tag through a side lever-lock (SSL). Such dessicant packaged and stored micronized opioid preparations may be used in the manufacturing processes, including the compounding processes described herein.

All of the raw materials were used as obtained from the various manufacturers with the following exceptions. The active ingredient (Oxycodone) was subject to a jet milling process to micronize the solid material into a substantially homogenous particle size. After collection from the jet mill apparatus, the micronized oxycodone was passed through a 20-mesh stainless steel screen and weighed. The CAB raw material was washed using ethanol (EtOH) to remove possible contaminants.

The amounts of active ingredients and excipients in various capsules of different strengths are set forth in Tables 13 through 17.

Table 13 sets forth the composition of exemplary 5.0 mg strength capsules (capsules comprising 5.0 mg oxycodone).

TABLE 13

| | Quantity per | |
|---|---|---|
| | Capsule | Quantity per |
| | (mg) (Study | Capsul (mg) |
| Component | Drug) | (Placebo) |
| Oxycodone base (micronized) | 5.0 | 0.0 |
| Sucrose acetate isobutyrate | 40.0 | 42.1 |
| Triacetin, USP | 26.6 | 28.1 |
| Isopropyl myristate, NF | 13.9 | 14.6 |
| Cellulose acetate butyrate, NF/EP, ethanol | 4.6 | 4.9 |
| washed (grade 381-20 BP) | | |
| Hydroxyethyl cellulose, NF | 5.5 | 5.9 |
| Colloidal silicon dioxide, NF | 1.8 | 2.0 |
| Butylated hydroxytoluene, NF | 0.02 | 0.02 |
| Total | 97.5 | 97.5 |

Table 14 sets forth the composition of exemplary 5.0 mg strength capsules (capsules comprising Table 19 sets forth the composition of exemplary 10.0 mg strength capsules (capsules comprising 10.0 mg oxycodone).

TABLE 14

| | Quantity per | |
|---|---|---|
| | Capsule | Quantity per |
| | (mg) (Study | Capsul (mg) |
| Component | Drug) | (Placebo) |
| Oxycodone base (micronized) | 10.0 | 0.0 |
| Sucrose acetate isobutyrate | 79.9 | 84.2 |
| Triacetin, USP | 53.3 | 56.1 |
| Isopropyl myristate, NF | 27.7 | 29.3 |
| Cellulose acetate butyrate, NF/EP, ethanol | 9.2 | 9.8 |
| washed (grade 381-20 BP) | | |
| Hydroxyethyl cellulose, NF | 11.1 | 11.7 |
| Colloidal silicon dioxide, NF | 3.7 | 3.9 |
| Butylated hydroxytoluene, NF | 0.04 | 0.04 |
| Total | 195.0 | 195.0 |

Table 15 sets forth the composition of exemplary 20.0 mg strength capsules (capsules comprising 20.0 mg oxycodone).

TABLE 15

| | Quantity per | |
|---|---|---|
| | Capsule | Quantity per |
| | (mg) (Study | Capsul (mg) |
| Component | Drug) | (Placebo) |
| Oxycodone base (micronized) | 20.0 | 0.0 |
| Sucrose acetate isobutyrate | 159.8 | 168.4 |
| Triacetin, USP | 106.5 | 112.3 |
| Isopropyl myristate, NF | 55.5 | 58.5 |
| Cellulose acetate butyrate, NF/EP, ethanol | 18.5 | 19.5 |
| washed (grade 381-20 BP) | | |
| Hydroxyethyl cellulose, NF | 22.2 | 23.4 |
| Collodal silicon dioxide NF | 7.4 | 7.8 |
| Butylated hydroxytoluene, NF | 0.08 | 0.08 |
| Total | 390.0 | 390.0 |

Table 16 sets forth the composition of exemplary 30.0 mg strength capsules (capsules comprising 30.0 mg oxycodone).

TABLE 16

| | Quantity per | |
|---|---|---|
| | Capsule | Quantity per |
| | (mg) (Study | Capsul (mg) |
| Component | Drug) | (Placebo) |
| Oxycodone base (micronized) | 30.0 | 0.0 |
| Sucrose acetate isobutyrate | 239.7 | 42.1 |
| Triacetin, USP | 159.8 | 28.1 |
| Isopropyl myristate, NF | 83.2 | 14.6 |
| Cellulose acetate butyrate, NF/EP, ethanol | 27.8 | 4.9 |
| washed (grade 381-20 BP) | | |
| Hydroxyethyl cellulose, NF | 33.3 | 5.9 |
| Colloidal silicon dioxide, NF | 11.1 | 2.0 |
| Butylated hydroxytoluene, NF | 0.12 | 0.02 |
| Total | 585.0 | |

Table 17 sets forth the composition of exemplary 40.0 mg strength capsules (capsules comprising 40.0 mg oxycodone).

TABLE 17

| | Quantity per | |
|---|---|---|
| | Capsule | Quantity per |
| | (mg) (Study | Capsul (mg) |
| Component | Drug) | (Placebo) |
| Oxycodone base (micronized) | 40.0 | 0.0 |
| Sucrose acetate isobutyrate | 319.6 | 336.9 |
| Triacetin, USP | 213.1 | 224.6 |
| Isopropyl myristate, NF | 111.0 | 117.0 |
| Cellulose acetate butyrate, NF/EP, ethanol | 37.0 | 39.0 |
| washed (grade 381-20 BP) | | |
| Hydroxyethyl cellulose, NF | 44.4 | 46.8 |
| Colloidal silicon dioxide, NF | 14.8 | 15.6 |
| Butylated hydroxytoluene, NF | 0.16 | 0.16 |
| Total | 780.0 | 780.0 |

As shown in Tables 13-17 above, the capsules of different strengths comprise active ingredients and excipients in the following % w/w: 5.13% Opioid (e.g., oxycodone, oxymorphone, hydrocodone or hydromorphone) either as base or salt (micronized or non-micronized); 40.98% Pharmaceutical Sucrose Acetate Isobutyrate (SAIB); 27.32% Triacetin, USP; 14.23% Isopropyl Myristate, NF (IPM); 4.74% Cellulose acetate butyrate, NF/EP, ethanol washed (e.g., grade 381-20 BP); 5.69% Hydroxyethyl cellulose, NF; 1.90% Colloidal silicon dioxide, NF; and 0.02% Butylated hydroxytoluene, NF. For a 60 mg or 80 mg capsule dosage form, the following alternative % w/w may be prepared and used as described herein (a) 10.26% Opioid (e.g., oxycodone, oxymorphone, hydrocodone or hydromorphone) either as base or salt (micronized or non-micronized); 36.21% Pharmaceutical Sucrose Acetate Isobutyrate (SAIB); 26.82% Triacetin, USP; 14.36% Isopropyl Myristate, NF; 4.94% Cellulose acetate butyrate, NF/EP, ethanol washed (e.g., grade 381-20 BP); 5.38% Hydroxyethyl cellulose, NF; 2.02% Colloidal silicon dioxide, NF; and 0.02% Butylated hydroxytoluene, NF; or (b) 10.26% Opioid (e.g., oxycodone, oxymorphone, hydrocodone or hydromorphone) either as base or salt (micronized or non-micronized); 36.46% Pharmaceutical Sucrose Acetate Isobutyrate (SAIB); 27.01% Triacetin, USP; 14.36% Isopropyl Myristate, NF; 5.38% Cellulose acetate butyrate, NF/EP, ethanol washed (e.g., grade 381-20 BP); 2.69% Hydroxyethyl cellulose, NF; 2.02% Colloidal silicon dioxide, NF; 1.79% Gelucire (e.g., 44/14), EP/NF; and 0.02% Butylated hydroxytoluene, NF.

Clinical supplies of oxycodone capsules or placebo capsules are packaged in plastic film blister packs with foil backing. The blister packs are placed inside a foil/foil pouch with a silica gel desiccant to assure that products conform to specifications while in use.

While the present disclosure has been described and illustrated herein by references to various specific materials, procedures and examples, it is understood that the disclosure is not restricted to the particular combinations of material and procedures selected for that purpose. Numerous variations of such details can be implied as will be appreciated by those skilled in the art. It is intended that the specification and examples be considered as exemplary, only, with the true scope and spirit of the disclosure being indicated by the following claims. All references, patents, and patent applications referred to in this application are herein incorporated by reference in their entirety.

1. A method for selecting subjects for a double-blind placebo-controlled clinical trial for testing the efficacy or safety of a drug, the method comprising,
(a) administering to subjects a range of amounts from low to high of a drug over an open label titration period to induce one or more adverse events in a subject; and
(b) selecting subjects for inclusion in the clinical trial that do not exhibit one or more unacceptable adverse events in response to an amount within the range of amounts of drug administered during the open label titration period.

2. A method for conducting a double-blind placebo controlled clinical trial, the method comprising,
(a) administering to subjects a range of amounts from low to high of a drug over an open label titration period to induce one or more adverse events in a subject; and
(b) selecting subjects for inclusion in the clinical trial that do not exhibit one or more unacceptable adverse events in response to an amount within the range of amounts of drug administered during the open label titration period; and
(c) randomizing the subjects selected in (b) into at least two groups for the clinical trial, wherein a first group in the clinical trial receives drug and a second group in the clinical trial receives placebo.

3. A method for conducting a double-blind placebo controlled clinical trial, the method comprising,
(a) administering to subjects an amount of a drug which may induce one or more adverse events in a subject over an open label titration period;
(b) selecting subjects that do not exhibit one or more unacceptable adverse events to the drug for the clinical trial;
(c) randomizing subjects selected in (b) into at least one first group to receive the drug and at least one second group to receive placebo;
(d) permitting an adjustment of the dosage of drug administered to subjects in the first group for a period of time; and
(e) fixing the dosage of drug administered to the subjects in the first group after the period of time in (d) has ended.

4. A method for conducting a clinical trial, the method comprising,
(a) a first phase comprising:
(i) administering to subjects an amount of a drug which may induce one or more adverse events in a subject over an open label titration period prior to the clinical trial, and
(ii) selecting subjects that do not exhibit one or more unacceptable adverse events to the drug for the clinical trial;
(b) a second phase comprising: randomizing subjects selected in the first phase into two or more groups;
(c) a third phase comprising: permitting an adjustment in the dosage of drug administered to subjects in one or more groups; and
(d) a fourth phase comprising: fixing the dosage of drug administered to the subjects in at least one of the groups in (c).

5. A method for conducting a clinical trial, the method comprising,
(a) a first phase comprising:
(i) administering to subjects an amount of a drug which may induce one or more adverse events in a subject over an open label titration period prior to the clinical trial, and
(ii) selecting subjects that do not exhibit one or more unacceptable adverse events to the drug for the clinical trial;
(b) a second phase comprising: randomizing subjects selected in the first phase into two or more groups;
(c) a third phase comprising: fixing the dosage of drug administered to the subjects in at least one of the groups in (b).

6. A method for conducting a double-blind placebo controlled clinical trial, the method comprising,
(a) administering to subjects an amount of a drug which may induce one or more adverse events in a subject over an open label titration period;
(b) selecting subjects that do not exhibit one or more unacceptable adverse events to the drug for the clinical trial;
(c) randomizing subjects selected in (b) into at least one first group to receive the drug and at least one second group to receive placebo; and
(d) permitting an adjustment of the dosage of drug administered to subjects in the first group.

7. A method for conducting a clinical trial, the method comprising,
(a) a first phase comprising:
(i) administering to subjects an amount of a drug which may induce one or more adverse events in a subject over an open label titration period prior to the clinical trial, and
(ii) selecting subjects that do not exhibit one or more unacceptable adverse events to the drug for the clinical trial;
(b) a second phase comprising: randomizing subjects selected in the first phase into two or more groups; and
(c) a third phase comprising: permitting an adjustment in the dosage of drug administered to subjects in one or more groups.

8. The method of any one of claims 1, 2, 3, 4, 5, 6 or 7, wherein the clinical trial is a phase II, III or IV clinical trial.

9. The method of any one of claims 1, 2, 3, 4, 5, 6 or 7, wherein the amount is the highest amount within the range of amounts of drug administered during the open label titration period.

10. The method of any one of claims 1, 2, 3, 4, 5, 6 or 7, wherein the drug is for the treatment of pain, arthritic condition or inflammation.

11. The method of any one of claims 2, 3, 4, 5, 6, 7, wherein the randomization of subjects is based on a stratification of subjects into subgroups based on a baseline assessment and an assessment during or at the end of the open-label titration period.

12. The method of claim 11, wherein the baseline assessment and the assessment during or at the end of the open-label titration period is an efficacy or safety parameter of the clinical trial.

13. The method of claim 12, wherein the drug is for the treatment of pain.

14. The method of claim 13, wherein the efficacy parameter is a pain intensity score.

15. The method of claim 14, wherein the stratification of subjects into subgroups is based on a baseline pain intensity score that is <7.5, or ≧7.5 and an average pain intensity score over the last two days of the open-label titration period that is <5 or ≧5.

16. The method of claim 15, wherein the subgroups are <7.5, <5; <7.5, ≧5; ≧7.5, <5; and ≧7.5, ≧5.

17. The method of any one of claims 1, 2, 3, 4, 5, 6 or 7 further comprising prior to step (a) subjecting the subjects to a washout period whereby the subjects discontinue medications prior to selecting subjects for the clinical trial.

18. The method of claim 17, wherein the patients discontinue medications other than acetaminophen during the washout period.

19. The method of claim 17, wherein the washout period is for multiple days.

20. The method of claim 17, wherein the washout period is for two or more days.

21. The method of claim 17, wherein the washout period is for four to ten days.

22. The method of any one of claims 1, 2, 3, 4, 5, 6 or 7, wherein the drug is administered every four hours.

23. The method of any one of claims 1, 2, 3, 4, 5, 6 or 7, wherein the drug is administered every eight hours.

24. The method of any one of claims 1, 2, 3, 4, 5, 6 or 7, wherein the drug is administered every twelve hours.

25. The method of any one of claims 1, 2, 3, 4, 5, 6 or 7, wherein the drug is administered every twenty-four hours.

26. The method of any one of claims 1, 2, 3, 4, 5, 6 or 7, wherein the drug is taken before with or after eating.

27. The method of any one of claims 1, 2, 3, 4, 5, 6 or 7, wherein the drug is taken before with or after meals.

28. The method of any one of claims 1, 2, 3, or 4, wherein the adjustment in the dosage is permitted during the initial weeks of the study period following the open label titration period.

29. The method of claim 28, wherein the initial weeks are the first four weeks of the study period following the open label titration period.

30. The method of any one of claims 1, 2, 3, or 4, wherein the adjustment in dosage is an increase in dosage.

31. The method of any one of claims 1, 2, 3, or 4, wherein the adjustment in dosage is a decrease in dosage.

32. The method of any one of claims 1, 2, 3, or 4, wherein an adjustment in dosage is not performed.

33. The method of any one of claims 1, 2, 3, or 4, wherein the drug is an opioid.

34. The method of any one of claims 1, 2, 3, or 4, wherein the opioid is oxycodone, oxymorphone, hydrocodone or hydromorphone.

35. The method of any one of claims 1, 2, 3, or 4, wherein the opioid is oxycodone.

36-77. (canceled)
